(19) United States
(12) Patent Application Publication
(10) Pub. No.: US 2003/0149615 A1
(43) Pub. Date: Aug. 7, 2003

(54) Method and system of performance-energetics estimation

(76) Inventor: William Andrew Robert Orban, Kanata (CA)

Correspondence Address: PEARNE & GORDON LLP, 526 SUPERIOR AVENUE EAST, SUITE 1200, CLEVELAND, OH, 44114-1484, US

(21) Appl. No.: 10/324,885

(22) Filed: Dec. 20, 2002

(30) Foreign Application Priority Data
Dec. 21, 2001 (CA) 2,366,178

(51) Int. Cl. G06F 17/60

(52) U.S. Cl. 705/11

(57) ABSTRACT

A method and system for performance-energetics estimation is provided. The system includes an input module, a transformation module and a core processor (core engine). The input module is an interactive module to collect individual data. The transformation module transforms the inputs into standard forms to provide them to the core engine. The core engine executes algorithms and equations based on basic laws to estimate individual parameters and provide a performance-energetic profile for the individual. The values of the parameters represent particular performance-energetic characteristics of the individual. The parameters (variables) are defined in universal standards. The outputs of the core engine can be utilized for creating unique training and fitness programs for the individual.

### FIELD OF THE INVENTION

The present invention relates to a data processing, more specifically a method and system to estimate individual's performance-energetics.

### BACKGROUND OF THE INVENTION

Fitness and training play a key role to improve one's physical condition. Over the last decade, many efforts have been made to develop fitness and training tools. However, today, it is well known that setting fitness and training programs affects mostly one's condition.

In order to create fitness and training programs suitable to each person, the person needs to know his fitness and training level.

Currently, analysis of variance (statistical sampling) is taken to provide assessment of training and fitness level for the individual. The individual determines his fitness and training level by comparing his data to the statistical data. However, statistical sampling approach is not based on individual characteristics and universal principles.

Sports trainers or coaches may assist the individual for creating personal training and fitness programs. However, the programs are based on the trainer's experience or his experience which is randomly applied to another individual.

Thus, those approaches are not always reliable and do not provide an objective assessment to the individual.

It is, therefore, desired to provide a method and system that can provide a reliable and an objective assessment of training and fitness level for the individual.

### SUMMARY OF THE INVENTION

It is an object of the present invention to provide a novel method and system, which obviates or mitigates at least the disadvantages of existing methods and systems.

In accordance with an aspect of the present invention, there is provided a method of providing a personalized capacity profile for an individual, which includes the steps of: inputting individual information, which includes a series of personal anthropometric measurements, physiological measurements, and measurements of performance; and processing the individual information to estimate one or more individual's parameters and provide, for the individual, a personalized performance-energetic profile of one's current and potential capacity. The parameters are defined on universal standards, and the data on the profile is dependent only on the individual's information.

In accordance with a further aspect of the present invention, there is provided a system for a system for providing a personalized profile to an individual, which includes an input module for inputting individual information and a core engine for processing the individual information to estimate one's parameters and provide, for the individual, a personalized performance-energetic profile. The system may further include a module for translating the information into a standard form for processing by the core engine.

Other aspects and features of the present invention will be readily apparent to those skilled in the art from a review of the following detailed description of preferred embodiments in conjunction with the accompanying drawings.

### BRIEF DESCRIPTION OF THE DRAWINGS

The invention will be further understood from the following description with reference to the drawings in which:

FIG. 1 is a schematic diagram showing a performance-energetics system in accordance with an embodiment of the present invention;

FIG. 2 is a schematic diagram showing one example of the performance-energetics system of FIG. 1;

FIG. 3 is a schematic diagram showing one example of an input module of FIG. 1;

FIG. 4 is a schematic diagram showing a measured-performance-class table;

FIG. 5 is a flow chart showing the operation of a physical activity history survey module of FIG. 3;

FIG. 6 is a flow chart showing the operation of a perceived exertion profile survey of FIG. 3;

FIG. 7 is a schematic diagram showing one example of a transformation module of FIG. 1;

FIG. 8 is a schematic diagram showing one example of a core engine of FIG. 1;

FIG. 9 is a schematic diagram showing one example of a module for definition and classification of body mass parameter shown in FIG. 8;

FIG. 10 is a schematic diagram showing one example of a module for performance assessment and classification shown in FIG. 8;

FIG. 11 is a schematic diagram showing one example of a module for estimating universal standards shown in FIG. 8;

FIG. 12 is a schematic diagram showing one example of a module for personal standard assessment and classification shown in FIG. 8;

FIG. 13 is a schematic diagram showing one example of a module for estimating a work parameter shown in FIG. 8;

FIG. 14 is a schematic diagram showing one example of a module for defining heart rate reserve parameters shown in FIG. 8;

FIG. 15 is a schematic diagram showing one example of a module for estimating an energy requirement shown in FIG. 8;

FIG. 16 is a schematic diagram showing one example of a module for estimating an energy requirement shown in FIG. 8;

FIG. 17 is a schematic diagram showing one example of a module for estimating a personal exertion level shown in FIG. 8;

FIG. 18 shows one example of a module for estimating a personal potential p-e capacity shown in FIG. 8.

### DETAILED DESCRIPTION OF THE PREFERRED EMBODIMENTS

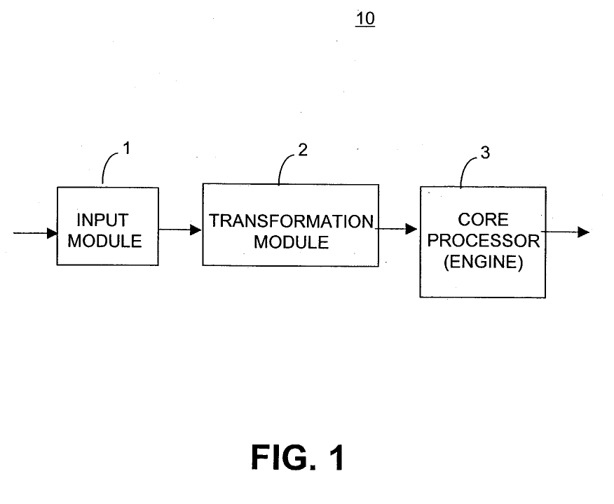

FIG. 1 shows a performance-energetics system 10 in accordance with an embodiment of the present invention. The performance-energetics system 10 shown in FIG. 1 includes an input module 1, a transformation module 2 and a core processor (core engine) 3. The user inputs individual's data in accordance with the instructions of the input module 1. The user may be the “individual (i.e. performer)” or may be a person who enters the data of that individual.

The transformation module 2 transforms the inputs into standard forms to provide them to the core processor 3. The core processor 3 provides a personalized performance-energetic profile for the individual. The profile is made up of variables. The variables are defined in universal standards relative to one or more of eight basic laws, which are described below.

The core processor 3 estimates parameters, i.e. the values of these variables. The value of each parameter is unique to each individual. The profile provides information about the current and potential level of training and fitness, and may be used in various ways to solve individual problems related to fitness and training programs for each person.

The data collected and produced in the system 10 may be recorded in a database (not shown). The system 10 may search data and display or process them.

The system 10 performs a series of algebraic equations and algorithms (referred to as “performance-energetics systems of equations (PESE)”), which solve a specific problem related to the individual's personal performance-energetics (PE) characteristics. The PESE is based on the laws of performance P1-P4 and the laws of performance-energetics PE1-PE4. The system 10 applies the laws P1-P4 and PE1-PE4 to each individual. The application of these laws provides complete personal performance and energetics information related to physical activity.

The laws of performance P1-P4 and laws of performance-energetics PE1-PE4 are now described in detail.

The first law of performance P1 is: At a constant distance, the duration is a linear function of the mean speed of any performance that is independent of the Class, External State or Internal State. The form of the equation is “y=ax”, where a=Δ, y=T, and x=s.

The second law of performance P2 is: At a constant mean speed, the duration is a linear function of the distance of any performance that is independent of the Class, External State or Internal State. The form of the equation is “y=ax”, where a=s, y=T and x=Δ.

The third law of performance P3 is: At a constant duration, the distance is an inverse hyperbolic function of the mean speed for any given performance. This is independent of the Class, External State or Internal State. The form of the equation is “k=xy”, where k=T, y=Δ and x=s.

“T” represents “time”, “Δ (or D)” represents “distance” and “s” represents “mean speed”.

The fourth law of performance P4 is: With maximal effort starting from a stationary position, the mean speed is a function of distance and duration until maximum speed is achieved (Acceleration phase). After reaching the acceleration phase, the distance and duration is an inverse function of the mean speed until exhaustion occurs (Deceleration phase). The acceleration phase curve approaches a hyperbola at the end points while the deceleration phase approaches a parabola at the end points. The locus (i.e. the xy rectangular coordinates of each performance) of the acceleration and deceleration. The locus varies with each performer's unique internal state.

The first law of performance-energetics PE1 is: The rate of energy expended per unit of time is a linear function of the mean speed of a performance, dependent on the Class, External State and Internal State. The form of the equation is “y=ax”. Where a=ED or WD, y=ET or WT and x=s.

The second law of performance-energetics PE2 is: At a constant mean speed, the energy time rate is a linear function of the energy distance rate and is dependent on the energy distance rate of the Class, External State or Internal State. The form of the equation is “y=ax”, where “a” is the constant mean speed, a=s, y=ET and x=ED.

The third law of performance-energetics PE3 is: At a constant rate of energy expenditure (ET/WT), the mean speed is an inverse hyperbolic function of the energy expended per unit distance (ED/WD). This is independent of the Class, External State or Internal State. The form of the equation is “k=xy, where k=ET or WT, y=ED or ET and x=s.

The fourth law of performance-energetics PE4 is: The work expenditure and the energy requirement in any performance is a linear function of the distance. This function is independent of the mean speed, Class, External State or Internal State. The form of the equation is “y=ax”, where a=WD/ED, y=W/E and x=d.

“ED” represents energy distance rate. “WD” represents work distance rate. “ET” represents “energy time rate”. “WT” represents “work time rate”. “W” represents “work expenditure”. “E” represents “energy requirement”.

Internal state is defined as the state of the performer's bio-physical characteristics as affected by age, gender, body mass, bio-mechanical or fitness and health condition. Class is any physical performance, which can be measured in distance and duration (time). External state is all the factors or external conditions, which affect the performance.

The PESE provides the process which mathematically evaluates and classifies each individual characteristic relative to the laws.

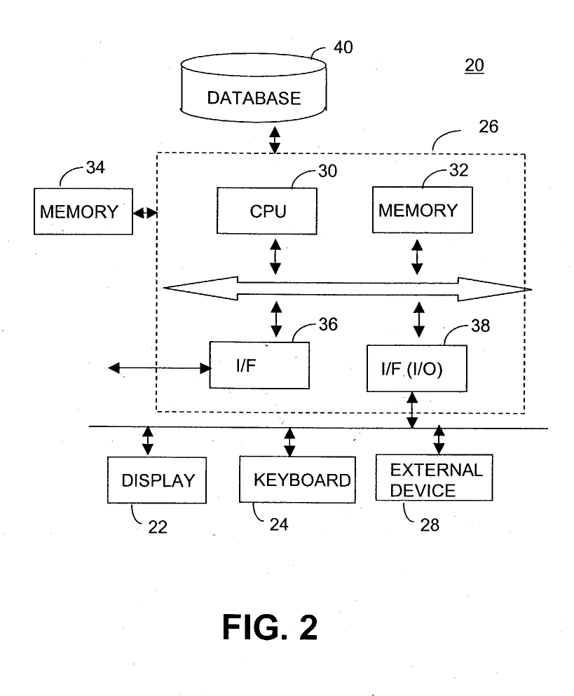

The performance-energetics system 10 may be a computer process utilizing mathematical equations. The performance-energetics system 10 may be performed by a computer system shown in FIG. 2.

FIG. 2 shows one example of the performance-energetics system 10 of FIG. 1. The computer system 20 of FIG. 2 includes a display 22, an input module (keyboard) 24, a computer 26 and external devices 28. The computer 26 may contain one or more processors or microprocessors, such as a central processing unit (CPU) 30. The CPU 30 performs arithmetic calculations and control functions to execute software stored in an internal memory 32, preferably random access memory (RAM) and/or read only memory (ROM), and possibly additional memory 34 and database 40. The additional memory 34 may include, for example, mass memory storage, hard disk drives, floppy disk drives, magnetic tape drives, compact disk drives, program cartridges and cartridge interfaces such as that found in video game devices, removable memory chips such as EPROM, or PROM, or similar storage media as known in the art. The additional memory 34 and the database 40 may be physically internal to the computer 26, or external as shown in FIG. 2.

The computer system 20 may also include other means for allowing computer programs or other instructions to be loaded. Such means can include, for example, a communications interface 36 that allows software and data to be transferred between the computer system 20 and external systems. Examples of communications interface 36 can include a modem, a network interface such as an Ethernet card, a serial or parallel communications port. Software and data transferred via communications interface 36 are in the form of signals which can be electronic, electromagnetic, optical or other signals capable of being received by the communications interface 36.

Input and output to and from the computer 26 is administered by the input/output (I/O) interface 38. This I/O interface 38 administers control of the display 22, keyboard 24, external devices 28 and other such components of the computer system 20. However, it would be clear to one skilled in the art that the invention may be applied to other computer.

The input module 1 of FIG. 1 is now described in detail. The input module 1 collects data. The input module 1 provides an instrument, which serves to accomplish the registration of the basic personal information and measurements. The input of the input module 1 is a series of personal anthropometric measurements, physiological measurements, and the measurements of performance (i.e. activity).

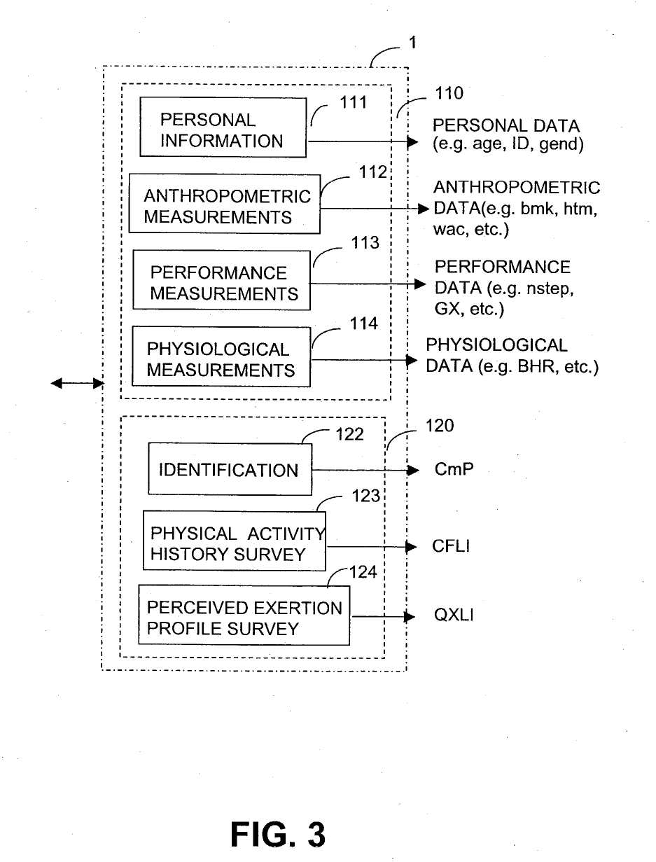

FIG. 3 shows an example of the input module 1 of FIG. 1. The input module 1 of FIG. 3 includes a data input module 110 and a question survey module 120.

The data input module 110 is an interactive module. The user inputs data in accordance with the instructions of the data input module 110. The data input module 110 includes a personal information input module 111, an anthropometric measurements input module 112, a performance measurements input module 113 and a physiological measurements input module 114.

The question survey module 120 is an interactive module, which provides questionnaires to the user. The user inputs answers to the questions in accordance with the instructions of the question survey module 120. The question survey module 120 includes an identification module 122, a physical activity history survey module 123 and a perceived exertion profile survey module 124.

Those modules 110-120 may be connected to the database 40 of FIG. 2 to read data from the database 40 or record data into the database 40. Those modules 110-120 may be connected to the display 22 of FIG. 2 to provide the instructions to the user and be connected to the input tool 24 of FIG. 2 so that the user enters data. The modules 110-120 may search information stored in the database 40, and provide pre-recorded data to the user. The user may enter new data that is to be updated.

The modules 111-114 of FIG. 3 are now described in detail. The personal information input module 111 requests the user to input personal information, such as name of performer (ID), birth data (age) and gender (gend).

The anthropometric measurements input module 112 requests the user to input individual's anthropometric data, such as a height and hip, waist and chest girths. In this embodiment, the user inputs weight in pounds (bmp) or in kilograms (bmk), height in feet (htf) and in inches (hti) or in centimeters (htc) or in meters (htm), waist girth in inches (wai) or in centimeters (wac), hip girth in inches (hpi), or in centimeters (hpc), chest girth in inches (chi) or in centimeters (chc).

The performance measurements input module 113 requests the user to select one of two sets of performances and input performance measurements (stair climb and track or graded and horizontal treadmill performances).

For the stair climb performance, the user is requested to input dimensions of the stairs (height and width), the number of flights and landings, and the duration of the performance and the terminal heart rate.

For the graded treadmill performance, the user is requested to input speed, grade of the treadmill performance, the terminal heart rate and terminal oxygen uptake.

The short class performance is a physical performance that has a short distance and short duration. For the short class performance, the user may be requested to input its distance and duration. The distance may be varied with the class, e.g. 800 m for walk-run, 100 m for swimming.

The long class performance is a physical performance, which has a longer distance compared to the short class performance. For the long class performance, the user input is the distance and duration. The distance varies with the class, e.g. 1200 m for walk-run, 300 m for swimming.

In the embodiment, the user selects (1) “stair climb” and “two walk-run outdoor 400 m track performances (two class performance in the same class and external state), or (2) “grade treadmill walk-run” and “two horizontal treadmill performances (two class performances in the same class and the external state)”.

The “two walk-run outdoor 400 m track performances” (hereinafter referred to as track performances) includes a walk-run performance on the outdoor 400 m track with a short distance and short duration, and a walk-run performance on the outdoor 400 m track with a long distance and long duration. The “two horizontal treadmill performances” includes a horizontal treadmill performance which a short distance and short duration, and a horizontal treadmill performance which a long distance and long duration.

As described in (1.1.3.1) and (1.1.3.2) set out below, when (1) is selected, the user is requested to input measurements in accordance with (1.1.3.1.1)-(1.1.3.1.7) and (1.1.3.2.1)-(1.1.3.2.4). For example, the inputs include the number of steps per flight (nstep), distance for short class performance (dy1, dm1 or dmi1 or dkm1), distance for long class performance (dy2, dm2 or dmi2 or dkm2).

As described in (1.1.3.3) and (1.1.3.4) set out below, when (2) is selected, the user is requested to input measurements in accordance with (1.1.3.3.2)(1.1.3.3.4) and (1.1.3.4.1)-(1.1.3.4.4). For example, the inputs include percent grade of the treadmill (GX), distance for short class performance (mph1 or kmph1), distance for long class performance (mph2 or kmph2).

The physiological measurements input module 114 is now described in detail. The physiological measurements input module 114 requests the user to input physiological measurements data, such as heart (pulse) rate data and oxygen uptake data.

In this embodiment, the user inputs: basal heart rate (BHR); terminal performance heart rate of stair climb or graded treadmill walk or run (THRx); terminal heart of number one walk-run performance (THR1); terminal heart of number two walk-run performance (THR2); and peak minute volume rate (liters per minute) of oxygen for all treadmill performances (vopkx, vopk1 and vopk2). The basal-heart rate may be taken in the morning before getting out of bed.

The question survey module 120 of FIG. 3 is now described in detail. Three kinds of questionnaires are presented to the user by the modules 122-124. The identification module 122 provides the first questionnaire to identify the class and external state of the mandatory performances, which are selected in the performance measurements input module 113 and for which the individual requests a precise estimate of the work expended and the energy that the individual requires. The survey modules 123-124 present two questionnaires regarding to a current fitness level and perception of maximum exertion of the individual.

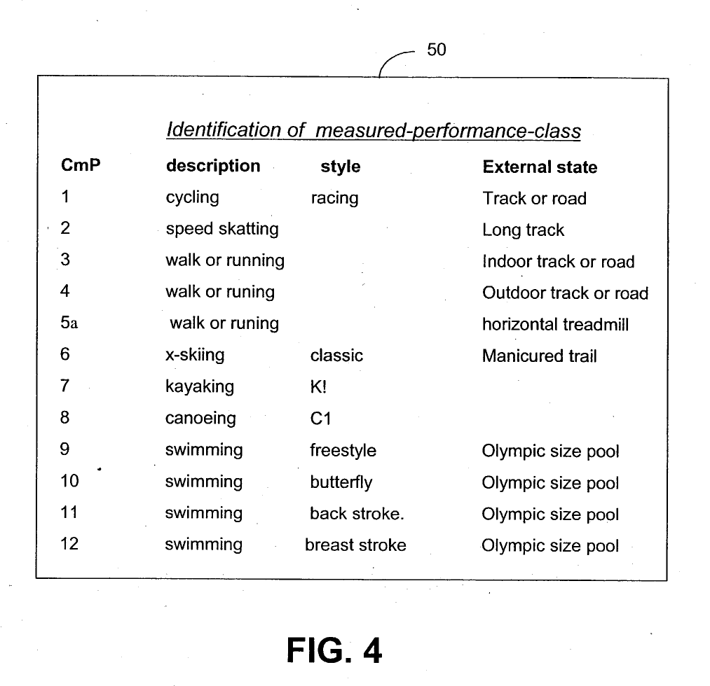

The identification module 122 is now described in detail. FIG. 4 shows one example of a measured-performance-class table 50 provided by the identification module 122. In FIG. 4, “CmP” represents “measured-performance-class” valuable. In the table 50, performances are divided into CmP 1 to CmP 12. The table 50 is provided to the user. The user is requested to select one CmP which is close to the selection in the module 113, i.e. (1) stair climb+track performance, or (2) graded treadmill+horizontal treadmill performances”.

The physical activity history survey module 123 of FIG. 3 is now described in detail. The physical activity history survey module 123 provides the second questionnaire, i.e., Fitness Level Index (CFLI) questionnaire.

The questionnaire for the index CFLI is a historical review of the physical activity of the performer. The questionnaire includes a series of questions in order to assign, the index CFLI, a score on a scale of 1 to 10. The score is a numerical value categorizing the level of fitness a person currently falls into (score range: 1 to 8, with 8 being the highest level of fitness).

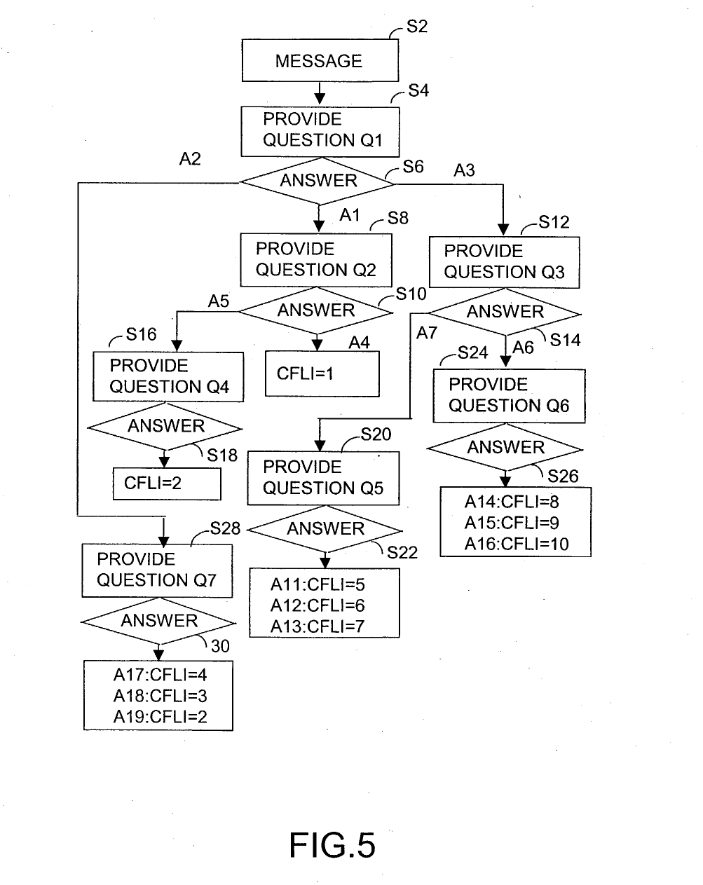

FIG. 5 is a flow chart showing the operation of the physical activity history survey module 123 of FIG. 3. Referring to FIG. 5, in step S2, an initial message is provided, i.e., “The following questions have been designed to help the Personal Fitness Trainer obtain a quick snapshot of how active you are. Answer each question by selecting the statement that best describes you. There is no right or wrong way to answer these questions. The more accurately you describe yourself, the better the Personal Fitness Trainer will be able to help you reach your goals.”

The display 22 of FIG. 2 or sounds tool may be used to provide the instructions to the user. In step S4, the user is requested to answer the question Q1.

Q1: “1. How would you best describe how physically active you are at this time? (select one answer only)”.

The answers A1-A3 of the question Q1 are also provided to the user.

A1: “I do not currently participate in any sport nor do any form of organized physical activity (e.g., fitness training, swimming, running)”;

A2: “I am physically active doing work either at home or in the office but I do not currently participate in any sport nor do any form of organized physical activity”;

A3: “I currently participate in a sport or I do some form of organized physical activity (e.g., fitness training, swimming, running)”.

In step S6, the user selects one answer from the answers A1-A3. When the user selects A1, the question Q2 is provided to the user. When the user selects A2, the question Q7 is provided to the user. When the user selects A3, the question Q3 is provided to the user. In step S8, the user is requested to answer the question Q2.

Q2: “2. How would you describe how physically active you used to be?”.

The answers A4-A5 of the question Q2 are also provided to the user.

A4: “I have never participated in a sport nor did any organized form of physical activity”;

A5: “I used to participate in a sport or in some form of organized physical activity”.

In step S10, the user selects one answer from the answers A4-A5. When the user selects A4, the index CFLI is set to “1”. When the user selects A5, the question Q4 is provided to the user. In step S12, the user is requested to answer the question Q3.

Q3: “3. Are you currently training for competition in a sport?”.

The answers A6-A7 of the question Q3 are provided to the user.

A6: “Yes”;

A7: “No”.

In step S14, the user selects one answer from the answers A6-A7. When the user selects A6, the question Q6 is provided to the user. When the user selects A7, the question Q5 is provided to the user. In step S16, the user is requested to answer the question Q4.

Q4: “4. Select the statement that best describes the type of physical activity that you used to do.”.

The answers A8-A10 of the question Q4 are also provided to the user.

A8: “I used to follow a self-exercise program”;

A9: “I used to do a recreational sport or was physically active in a sports club”;

A10: “I used to follow a supervised fitness training program”.

In step S18, the user selects one answer from the answers A8-A10. The index CFLI is set to “2”. In step S20, the user is requested to answer the question Q5.

Q5: “5. Select the statement that best describes the type of physical activity you are currently doing.”.

The answers A11-A13 of the question Q5 are also provided to the user.

A11: “I follow a self-exercise program”;

A12: “I participate in a recreational sport or I am physically active in a sports club”;

A13: “I follow a supervised fitness training program”.

In step S22, the user selects one answer from the answers A11-A13. When the user selects A11, the index CFLI is set to “5”. When the user selects A12, the index CFLI is set to “6”. When the user selects A13, the index CFLI is set to “7”. In step S24, the user is requested to answer the question Q6.

Q6: “6. At which level of competition are you currently training for or are competing at? (select the highest level)”.

The answers A14-A16 of the question Q6 are also provided to the user.

A14: “Local”;

A15: “State or Provincial”;

A16: “National or International”.

In step S26, the user selects one answer from the answers A14-A16. When the user selects A14, the index CFLI is set to “8”. When the user selects A15, the index CFLI is set to “9”. When the user selects A16, the index CFLI is set to “10”. In step S28, the user is requested to answer the question Q7.

Q7: “7. How would you best describe how physically active you are throughout your typical day?”.

The answers A17-A19 of the question Q7 are also provided to the user.

A17: “Very active”;

A18: “Somewhat Active”;

A19: “Very Little or Not Active At All”.

In step S30, the user selects one answer from the answers A17-A19. When the user selects A17, the index CFLI is set to “4”. When the user selects A18, the index CFLI is set to “3”. When the user selects A19, the index CFLI is set to “2”. When the value of the index CFLI is fixed, the questionnaire ends.

The perceived exertion profile survey 124 of FIG. 3 is now described in detail. The perceived exertion profile survey 124 provides the third questionnaire, i.e., Perceived exertion level Index (QXLI) variable questionnaire to assess the perception of maximal exertion. The questionnaire includes a series of questions to assign, to the index QXLI, a score on a scale of 1 to 10.

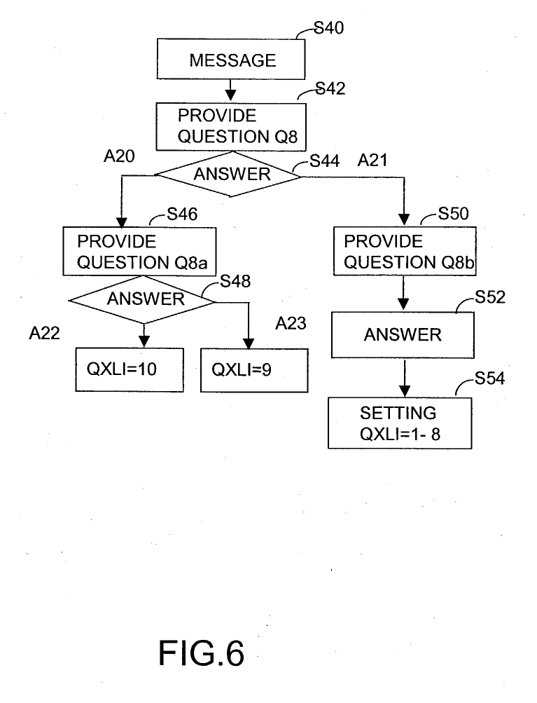

FIG. 6 is a flow chart showing the operation of the perceived exertion profile survey 124 of FIG. 3. Referring to FIG. 6, the questionnaire includes three main questions Q8, Q8a and Q8b. In the step S40, the message, i.e., “Each question must be answered by a Yes of No.” is provided to the user. In step S42, the user is requested to answer the question Q8.

Q8: “8. Have you ever pushed yourself to the point of exhaustion when doing a sport or physical activity?”.

The answers A20-A21 of the question Q8 are also provided to the user.

A20: “Yes”;

A21: “No”.

In step S44, the user selects one answer from the answers A20-A21. When the user selects A20, the question Q8a is provided to the user. When the user selects A21, the question Q8b is provided to the user. In step S46, the user is requested to answer the question Q8a.

Q8a: “8a. Have you ever pushed yourself past the point you felt exhausted (usually described as hitting the wall)?”.

The answers A22-A23 of the question Q8a are also provided to the user.

A22: “Yes” (QXLI=10);

A23: “No” (QXLI=9).ps

In step S48, the user selects one answer from the answers A22-A23. When the user selects A22, the index QXLI is set to “10”. When the user selects A23, the index QXLI is set to “9”. In step S50, the message, i.e., “8b. Indicate for each of the following whether or not it is a reason for causing you to stop when trying to do a physical activity quickly”, is provided to the user. The questions Q8ba-Q8be are also provided to the user. The user is requested to answer the questions Q8ba-Q8be.

Q8ba: Feel Spent Yes or No

Q8bb: Feeling Breathless Yes or No

Q8bc: Feeling Tired Yes or No

Q8bd: Fear of Hurting Self Yes or No

Q8be: Other Reasons Yes or No

In step S52, the user selects “Yes” or “No” for each question Q8ba-Q8be. In step S56, the module 124 outputs the index QXLI based on the answers to the questions Q8ba-Q8be in accordance with the following algorithm.

If Yes to Q8be, QXLI=1

If Yes to Q8bd and Yes to any other and No to Q8be (or No to Q8ba)*, QXLI=2

If Yes to Q8bd and No to any other answer or No to Q8ba, QXLI=3

If Yes to Q8bc and Yes to any other answer and No to Q8be or Q8ba, QXLI=4

If Yes to Q8bc and No to any other answer, QXLI=5

If Yes to Q8bb and No to any other answer, QXLI=6

If Yes to Q8bb and Yes to Q8ba and No to any other answer, QXLI=7

If Yes to Q8ba and No to any other answer, QXLI=8

End.

When the value of the index QXLI is fixed, the questionnaire ends.

The transformation module 2 of FIG. 1 is now described in detail. The transformation module 2 serves as an interface between the input module 1 of FIG. 1 and the core processor 3 of FIG. 1. Input information obtained in the input module 1 may be in metric or imperial units. On the other hand, in this embodiment, the core processor 3 processes terms in standard forms, i.e., distances in kilometers, time in hours, weight in kilograms and volumes in liters. The transformation module 2 converts the input terms in the input module 1 into metric units and transforms them into standard numerical forms to provide them to the core processor 3. The numerical terms in this form provide unknown variables, which are used by the core processor 3. In the system 10 of FIG. 1, all input variables are converted to numerical terms.

For example, distance for a measured performance can be inputted in miles, yards, meters or kilometers. The standard form of the term that is handled by the core processor 3 is the reciprocal of the distance in kilometers. Similarly the volume of oxygen uptake is entered in liters. The core processor 3 utilizes oxygen undertake in kilocalories. The transformation module 2 calculates distance in kilometers when it is entered in miles, yards, meters. The transformation module 2 calculates oxygen undertake in kilocalories when it is entered in liters.

Another example is mechanical work. The transformation module 2 calculates the vertical height of a stair climb or graded treadmill run and multiplies it by the body mass to yield kilogram-meters of work. To achieve this, the body mass input is converted to kilograms if it is entered in imperial units. The variable of kilogram force of mechanical work is then converted into kilocalories, which can be used by the core processor 3.

The transformation module 2 includes sub-modules, each of which defines a number of appropriate factors to accomplish the conversion and transformation.

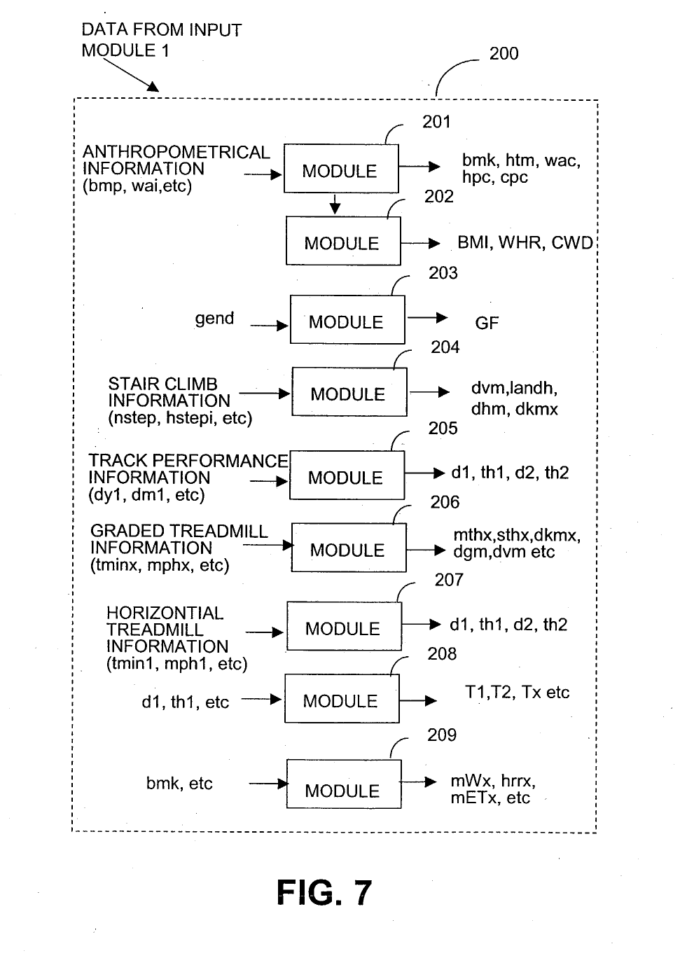

FIG. 7 shows an example of the transformation module 2 of FIG. 1. The transformation module 2 of FIG. 7 includes eight sub-modules 201-208

The module 201 converts the anthropometrical measurements to numerical terms in metric units. Input data (bmp, htf, hti, wai, hpi and chi) is converted in accordance with (2.1.1)-(2.1.4) including (2.1.4.1)-(2.1.4.6) as set out below. Factors bmkF, fmF, imF and icmF are used.

The weight in pounds (bmp) is converted into a numerical term (bmk) in kilograms. The height in feet (htf) and in inches (hti) is converted into a numerical term (hmt) in meters. The waist girth in inches (wai) is converted into a numerical term (wac) in centimeters. The hip girth in inches (hpi) is converted into a numerical term (hpc) in centimeters. The chest girth in inches (chi) is converted into a numerical term (chc) value in centimeters.

The module 202 transforms the outputs of the anthropometrical module 201 into three basic indexes (referred to as body mass indexes) BMI, WHR and CWD, which are used by the core processor 3 of FIG. 1. The indexes are produced based on bmk, htm, wac, hpc and chc in accordance with (2.2.1)-(2.2.3) as set out below.

The module 203 transforms the gender input into a numerical term. i.e., gender factor GF. The gender factor GF is produced in accordance with (2.3.1)-(2.3.2) at set out below. Where “gend” represents the input gender, “M” represents man and “F” represents “Female”.

The module 204 converts the input measurements related to the stair climb performance, which are obtained in the input module 1, into metric units, and then transforms into standard PESE form. For example the horizontal distance (width of steps and landings) are transformed into horizontal distance in kilometers).

As described in (2.4.1)-(2.4.4), when “stair climb” is selected in the input module 1, vertical distance conditional estimate and horizontal distance conditional estimate are performed. Factors cmF, mtkmF and IdhF are used.

According to (2.4.4.3)-(2.4.4.5), “dvm” is output as the vertical distance conditional estimate. According to (2.4.5.1)-(2.4.5.7), “dhm” and “dkmx” are output as the horizontal distance conditional estimate.

The module 205 converts the input measurements related to the two class performances into metric units. In this embodiment, the module 205 converts the input measurements in accordance with (2.5.1) and (2.5.2) as set out below, when the “track performances” is selected in the input module 1.

In accordance with (2.5.1.1)-(2.5.1.6), the module 205 outputs “d1” and “th1” for the short class performance. In accordance with (2.5.2.1)-(2.5.2.6), the module 205 outputs “d2” and “th2” for the long class performance. Factors ykmF, mikmF, mtkmF, mhF and shF are used.

The module 206 converts the input measurements related to the graded treadmill performance, which are obtained in the input module 1, into metric units, and then transforms into standard PESE form.

The input measurements are converted and transformed in accordance with (2.6.1)-(2.6.4), (2.6.4.1)-(2.6.4.18) as set out below, when the “graded treadmill performance” is selected in the input module 1. Factors mikmF, ykmF, mhF and shF are used.

The module 207 converts the input measurements related to the two class performances into metric units. In this embodiment, the module 207 converts the input measurements of the horizontal treadmill performances in accordance with (2.7.1)-(2.7.2) as set out below, when the “horizontal treadmill performances” is selected in the input module 1.

The module 207 outputs th1, th2, dmi1 and d1 or dmi2 and d2 in accordance with (2.7.1.1)-(2.7.1.2) and (2.7.2.1) and (2.7.2.6) set out below. Factors mhF, shF and mikmF are used.

The PESE parameters module 208 is now described in detail. As described in (2.8.1) and (2.8.2), the PESE parameters module 208 defines basic PESE parameters based on the three measured performances, i.e. the output of the stair climb module 204 or the output of the graded treadmill module 206 and the output of the two class performances module 205 or 207.

According to (2.8.1.1)-(2.8.1.3), the mean speed of the three measured performances is defined. The module 208. outputs “sₓ”, “s₁” and “S₂”.

According to (2.8.2.1)-(2.8.2.6), the distance and duration parameters of the three measured performances are defined. The module 208 outputs “Dₓ”, “D₁”, “D₂”, “Tₓ”, “T₁” and “T₂”.

The module 209 converts energetics measurements, such as work, oxygen uptake, terminal heart rate, and then transforms them into standard PESE parameters.

The equations and algorithms in the module 209 are described in (2.9.1), (2.9.2) and (2.9.3) including (2.9.1.1)-(2.9.1.5), (2.9.2.1)-(2.9.2.4) and (2.9.3.1)-(2.9.3.4). The module 208 outputs the mWx, hrrx, hrr1, hrr2, mETx, mET1 and mET2 to the core processor 3.

Referring to FIG. 1, the core processor 3 is now described in detail. The core processor 3 assesses and analyzes a series of individual input anthropometric, physiological, oxygen consumption and performance variables by applying the laws P1-P4 and PE1-PE4 to generate parameters.

Each parameter is a numerical representation of a particular p-e characteristic of the individual. These parameters provide information about one's potential capacity and how to achieve his goal in a time effective manner.

The core processor 3 is a sequence of systems of algebraic equations, which vary dependent on the solution sought. The equations are grouped when they have a common purpose. A sub-module generally is of such a structure. When certain conditions have to be met then the module and the sub-module may include a sequence of conditional statements, which provides one or more parameter that satisfies the individual's particular characteristics or selection of input performances.

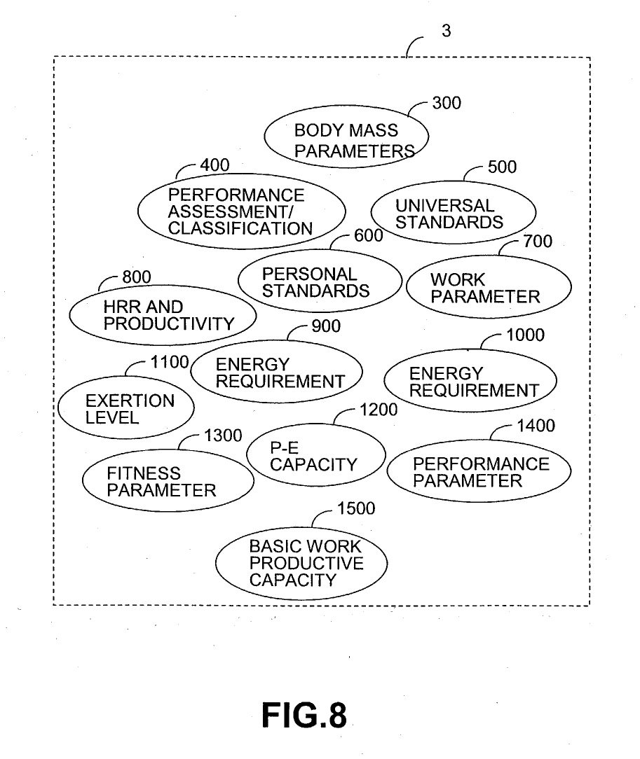

FIG. 8 shows one example of the core processor 3 of FIG. 1. The core processor 3 of FIG. 8 includes a module 300 for definition and classification of body mass parameter, a module 400 for performance assessment and classification, a module 500 for estimating universal standards, a module 600 for personal standard assessment and classification, a module 700 for estimating work parameter, a module 800 for defining heart rate reserve (HRR) parameters and productivity, modules 900 and 1000 for estimating energy requirements, a module 1100 for estimating a personal exertion level, a module 1200 for estimating a personal potential p-e capacity, a module 1300 for defining current and potential fitness parameters, a module 1400 for estimating the relevant stair climb or graded treadmill performance parameters, and a module 1500 for estimating the basic work productivity capacity of the performer.

The module 300 is now described in detail. The module 300 defines body mass parameter and performs classification using the indexers BMI, WHR and CWD produced by the input module 1. The classification may reflect the age, gender and physical characteristics of body mass, height, muscle mass, body-fat and body type. These characteristics are closely related to an individual's p-e potential capacity profile.

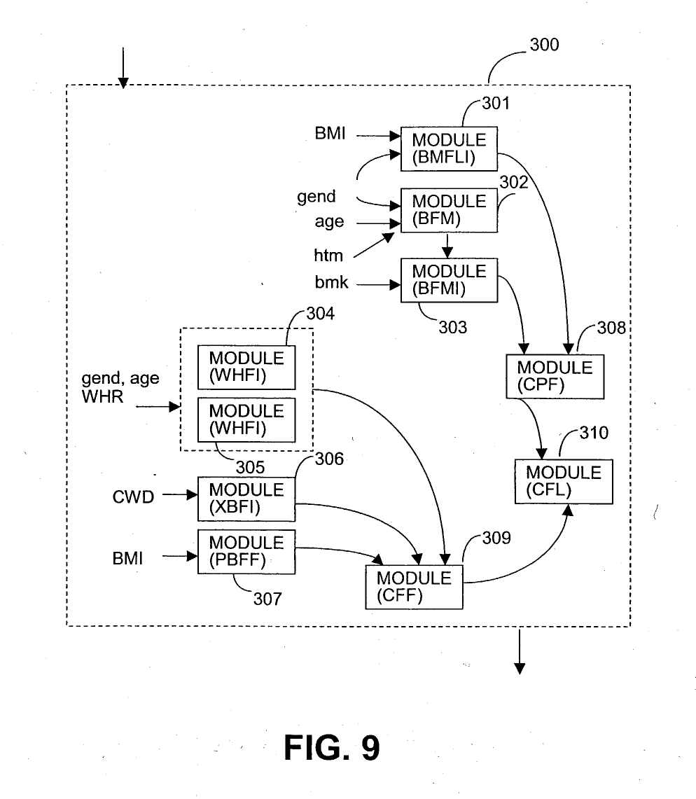

The module 300 contains one or more sub-modules, each of which includes a series of conditional statements and equations. FIG. 9 shows one example of the body mass indexes and classification module 300. The module 300 of FIG. 9 includes module 301-310.

The module 301 assigns, to the individual, a body mass fitness level index BMFLI on a scale of 1 to 10. The index BMFLI is determined based on the index BMI and gender of the individual in accordance with (3.1.1)-(3.1.22) as set out below. When the gender of the individual is a “Man (M)”, (3.1.2)-(3.1.11) are applied. When the gender of the individual is a “Female (F)”, (3.1.13)-(3.1.22) are applied.

The module 302 estimates a fit body mass BFM of the individual. The fit body mass BFM is calculated based on the gender, age and htm of the individual in accordance with (3.2.1)-(3.2.18) as set out below.

The module 303 assigns, to the individual, a body fit mass index BFMI on a scale of 1 to 10. The index BFMI is determined based on the BFM and bmk of the individual in accordance with (3.3.1)-(3.3.21) set out below.

The module 304 assigns, to the individual, a waist-hip factor index WHFI on a scale of 1 to 10 when the gender of the individual is a “Man (M)”. The male waist-hip factor index WHFI is determined based on the body mass index WHR, gender and age of the individual in accordance with (3.4.1)-(3.4.22) as set out below.

The module 305 assigns, to the individual, a waist-hip factor index WHFI on a scale of 1 to 10 when the gender of the individual is a “Female (F)”. The female waist-hip factor index WHFI is determined based on the body mass index WHR, gender and age of the individual in accordance with (3.5.1)-(3.5.22) as set out below.

The module 306 assigns, to the individual, a chest-waist body fat index XBFI on a scale of 1 to 10. The index XBFI is determined based on the body mass index CWD of the individual in accordance with (3.6.1)-(3.6.12) as set out below. The XBFI is used to classify the difference of each individual, which is then used further on as an indicator of potential fitness and performance.

The module 307 assigns, to the individual, a percent body fat factor PBFF on a scale of 1 to 10. The factor PBFF is determined based on the body mass index BMI of the individual in accordance with (3.7.1)-(3.7.20) set out below. The PBFF is used to assist the assessment of current and potential fitness.

The module 308 assigns, to the individual, a current body fat CPF on a scale of 1 to 10. In this embodiment, the CPF is calculated based on the BMFLI and the BFMI of the individual in accordance with (3.8.1)-(3.8.11) as set out below.

The module 309 assigns, to the individual, a current fat factor CFF on a scale of 1 to 10. The current fat factor CFF is determined in accordance with (3.9.1)-(3.9.11) as set out below, using the waist-hip factor index WHFI, chest-waist body fat index XBFI and percent body fat factor PBFF of the individual. The CFF is used on to estimate current level of fitness.

The module 310 estimates a current body fat level CFL for the individual based on the CFF and CPF of the individual. In this embodiment, the current fat level CFL is calculated in accordance with (3.10.1) set out below.

The module 400 is now described in detail. The module 400 generates p-e parameters, which are used to estimate universal standards and classification of the individual as described below.

In order to provide a unique profile for the individual, all the physical and physiological characteristics, which contribute to or are affected by the basic laws, are numerically defined and incorporated into the systems of equations. The module 400 estimates personalized factors (i.e. parameters) to identify the physical and physiological characteristics of the individual.

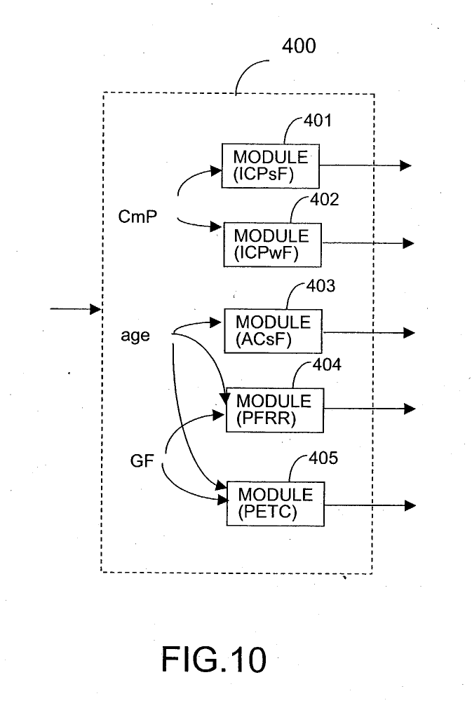

FIG. 10 shows one example of the performance assessment and classification module 400 shown in FIG. 8. The module 400 of FIG. 10 includes modules 401-405.

The module 401 generates an interclass performance speed factor ICPsF which is related to the selected class and external state of the measured performances. In this embodiment, the factor ICPsF is determined based on the CmP in accordance with (4.1.1)-(4.1.22) as set out below.

The module 402 generates an interclass energetics factor ICPwF which is related to the selected class and external state of the measured performances. In this embodiment, the factor ICPwF is determined based on CmP in accordance with (4.2.1)-(4.2.22) as set out below.

The module 403 generates an age class speed factor ACsF related to the selected class and external state of the measured performances. In this embodiment, the factor ACsF is determined based on individual's age in accordance with (4.3.1)-(4.3.38) as set out below.

The module 404 generates an age class heart rate reserve PHRR. In this embodiment, the PHRR is provided based on the age and GF of the individual in accordance with (4.4.1)-(4.4.38) as set out below.

The module 405 generates an age class energetics capacity PRTC. In this embodiment, the capacity PETC is provided based on individual's age and GF in accordance with (4.5.1)-(4.5.38) as set out below.

The module 500 of FIG. 8 is now described in detail. The module 500 generates universal performance standards, i.e. maximal human performance capacity. It also estimates the particular individual current location of the individual on the universal scalar standard for the selected class performance.

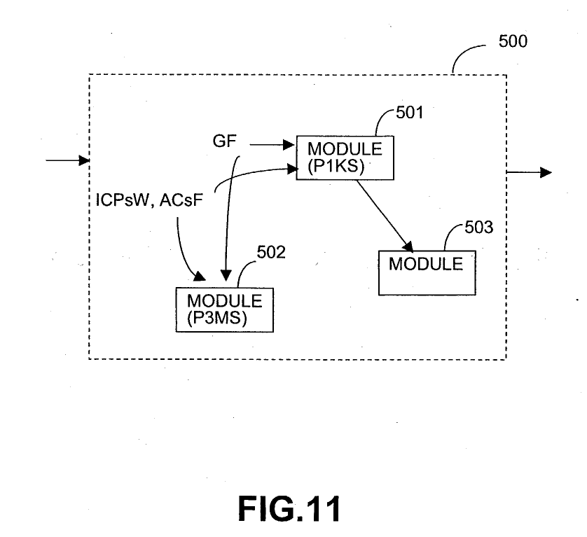

FIG. 11 shows one example of the universal standards estimate module 500 of FIG. 8. The module 500 of FIG. 11 includes three modules 501-503, each of which defines basic parameters to be used in applying the universal and particular standards. Each module includes equations utilizing parameters from other modules or defining new parameters.

The module 501 defines an age-gender-distance-class performance standard (P1KS). In this embodiment, the P1KS is produced based on individual's ACsF, ICPsF and GF in accordance with (5.1.1)-(5.1.2) as set out below. The module 502 defines an age-gender-time-class performance standard (P3MS). In this embodiment, the P3MS is produced based on individual's ACsF, ICPsF and GF in accordance with (5.2.1)-(5.2.2) as set out below. The module 503 defines standard parameters. In this embodiment, the standard parameters D1KS, T3M3, T3MSx, PD1KS, PT1KS, PT3MS, UT3M and UTKS are set in accordance with (5.3.1)-(5.3.8) as set out below.

The module 600 of FIG. 8 is now described. The module 600 determines a standard performance that is equivalent to the input measured performance. In this embodiment, the module 600 estimates one kilometer (1KS) and three minute (3MS) performance that are equivalent to the two measured performances. The estimated “one kilometer performance” represents the maximal performance that the performer can perform in one kilometer. The “three minute maximum performance” represents a maximal performance that the performer can perform in three minutes.

The module 600 solves the slope, y-intercepts, and intersection of one kilometer and three minute performance radius vectors for a particular performance profile of the individual. It also defines the radius vectors of the relevant parameters of the generated intersections and y-intercepts.

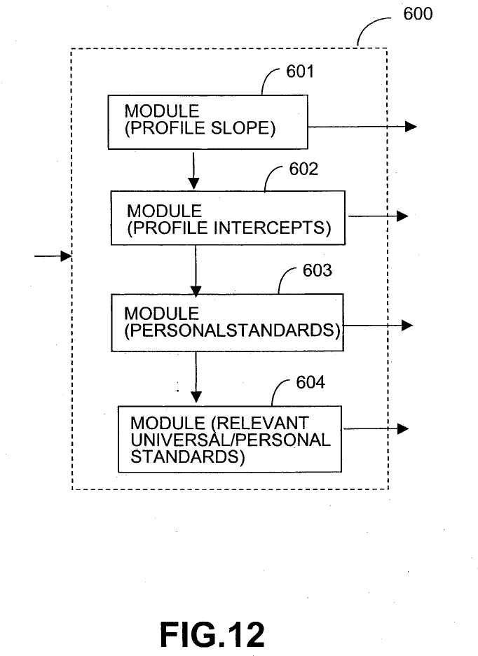

FIG. 12 shows one example of the personal standard assessment and classification module 600 of FIG. 8. The module 600 of FIG. 12 includes four modules 601-604. The module 601 defines profile slopes m, Pm and Um in accordance with (6.1.1)-(6.1.3) as set out below. The module 602 defines profile intercepts of the measured class performances b, Pb and Ub in accordance with (6.2.1)-(6.2.3). The module 603 defines basic personal standards 1KS, 1KSx, 3MS and 3MSx in accordance with (6.3.1)-(6.3.5) as set out below. The module 604 defines relevant universal and personal standards in accordance with (6.4.1)-(6.4.20) as set out below. The parameters include T1KS, rsK, rsPK, rsUKS, RPKS, RUKS, rs3M, D3MS, d3MS, PD3MS, Pd3MS, Rd3MS, rsP3M, RP3MS, UD3MS, Ud3MS, RdU3MS, rsU3MS, RU3MS and RrsKM.

The module 700 of FIG. 8 is now described in detail. The module 700 estimates basic work per distance parameter, basic work per time parameter and defines radius vectors of work standards.

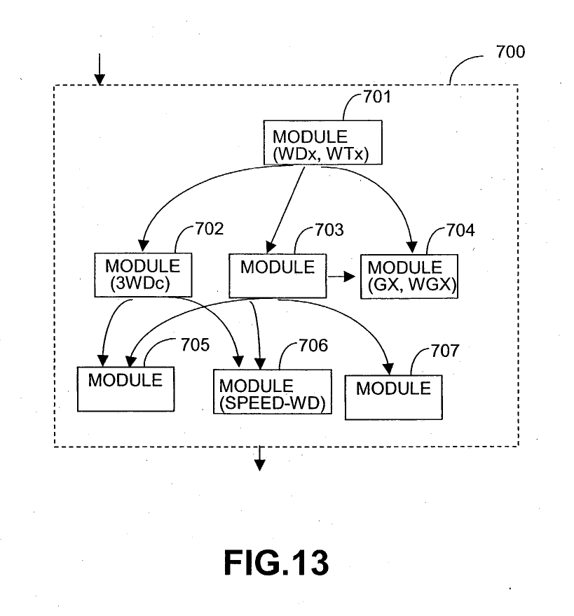

FIG. 13 shows one example of the work parameter estimate module 700 of FIG. 8. The module 700 includes seven modules 701-707, each of which contains a series of equations.

The module 701 estimates basic work parameters, WDx and WTx in accordance with (7.1) including (7.1.1)-(7.1.2) as set out below.

The module 702 performs iteration loop in accordance with (7.2.1)-(7.2.14) as set out below to estimate 3WDc which is the local variable of the WD for the varialbe 3MS. The module 703 defines walk-run class work rate parameters, such as WDc, WDcx in accordance with (7.3) including (7.3.1)-(7.3.8) as set out below. The module 704 defines the grade and work per grade of X performance in accordance with (7.4) including (7.4.1)-(7.4.2) as set out below. The X variable is the iterated local variable. The module 705 defines the work of each type in iteration in accordance with (7.5) including (7.5.1)-(7.5.9) as set out below. The module 706 estimates the speed-WD ratios of work in accordance with (7.6) including (7.6.1)-(7.6.4) as set out below. The module 707 defines radius vectors of work standards rsWK, rsW3M and RrsWKM in accordance with (7.7) including (7.7.1)-(7.7.3) as set out below.

The module 700 solves the work (mkg) which the individual performs in any type of performance. The inputs of the body mass, the stair climb performance or the treadmill performance are provided to the module 700. The module 700 uses those inputs to apply the laws, i.e. P1-P4 and PE1-PE4. The output is a precise estimate of the work in kcal and energy required in kcal that the individual requires to perform the target performance for which he wants to train. The variable WDc can be used in many ways to solve fitness problems.

The module 800 of FIG. 8 is now defined in detail. The module 800 defines heart rate reserve (HRR) parameters and productivity. The basal heart rate and the terminal heart rate input measures provide the variables to the series of equations, which solve for several parameters used by subsequent modules as described below.

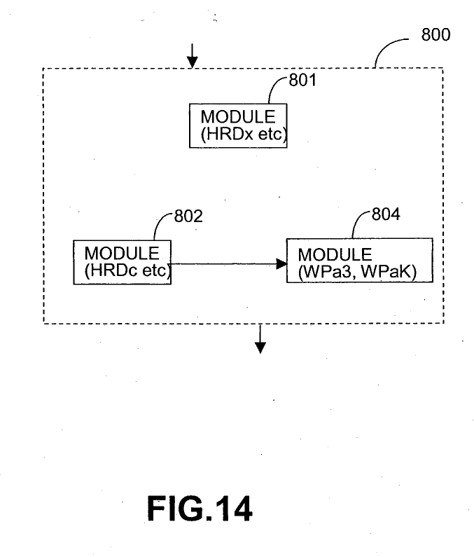

FIG. 14 shows one example of the heart rate reserve parameters module 800 of FIG. 8. The module 800 includes three sub-modules 801-803. The module 801 defines variables HRDx, HRTKx and HRT3Mx in accordance with (8.1) including (8.1.1)-(8.1.3) as set out below. The module 802 defines relevant parameters HRRD1, HRRD2, HRD1, HRD2, HRDc, HRTKc, HRT3Mc and RHRT in accordance with (8.2) including (8.2.1)-(8.2.8) as set out below. The module 803 defines WPa parameters WPa3 and WPaK for 1KS and 3MS (1 kilometer and three minute) in accordance with (8.3) including (8.3.1)-(8.3.2) as set out below.

The module 900 of FIG. 8 is now described in detail. The module 900 estimates ED parameters related to energy requirement when treadmill performance is selected in the input module 1 of FIG. 1.

The module 900 estimates the energy requirement from the oxygen uptake input measurement and generates a series of energy requirement parameters. This module is also the key for analysis and modification process for the clinical reduction of error of measurement in oxygen uptake (module 17).

The process of the module 900 includes conditional loops to estimate ED and ET parameters.

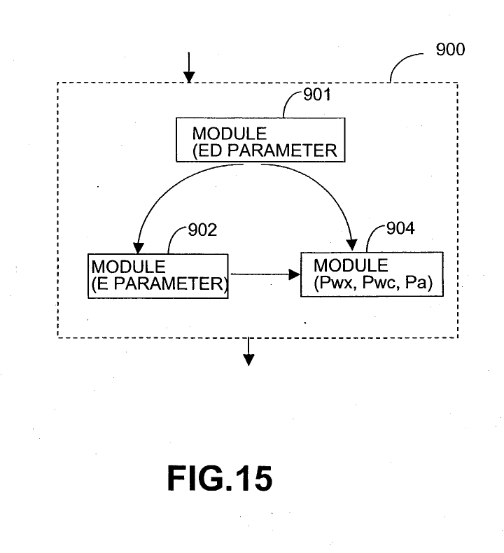

FIG. 15 shows one example of the energy requirement estimate module 900 of FIG. 8. The module 900 includes three sub-modules 901-903, each with a series of PESE equations.

The module 901 estimates ED parameters related to energy requirement in accordance with (9.1.1)-(9.1.10) as set out below. The module 902 estimates relevant energy requirement parameters in accordance with (9.2.1)-(9.2.11) as set out below.

The module 903 estimates Pwcx, Pwc and Pa parameters in accordance with (9.3.1)-(9.3.3) as set out below. “Pa” stands for “Productivity of aerobic”. “Pw” stands for “Productivity of work”. As described in (9.1.1)-(9.3.4), the modules 901-903 execute their processes when mETx≠0 and mET1 or mET2≠0.

The module 1000 of FIG. 8 is now described in detail. The module 1000 estimates ED parameters when mETx=0.

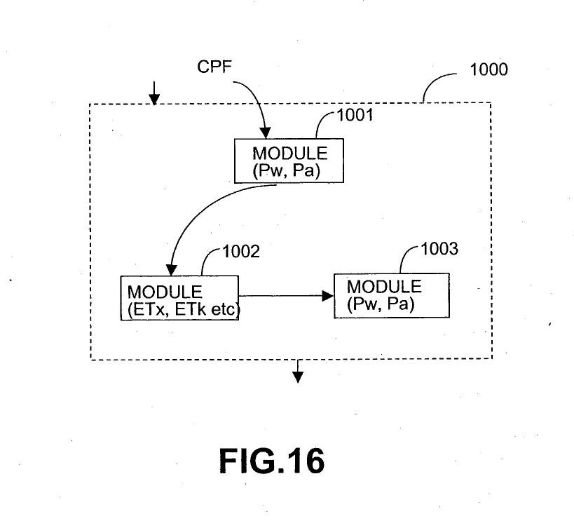

FIG. 16 shows one example of the energy requirement estimate module 1000 of FIG. 8. The module 1000 includes modules 1001-1003. The module 1001 defines parameters Pw and Pa based on the CPF in accordance with (10.1.1)-(10.1.10) as set out below. The module 1002 defines relevant parameters in accordance with (10.2.1)-(10.2.12) as set out below. The module 1003 re-estimates Pw and Pa parameters and outputs Pwc, Pwx, Pax and Pac in accordance with (10.3.1)-(10.3.4) as set out below. The CPF parameter is used in a series of conditional statements to assign appropriate work productivity (Pw) and aerobic productivity (Pa) to the individual. With these parameters, the appropriate energy requirements are assigned.

The module 1100 of FIG. 8 is now described. The module 1100 utilizes the paramaters which includes standards, work capacity, energy requirement capacity and the herart rate reserve parameters to determine an exertion level (MXL) of the individual.

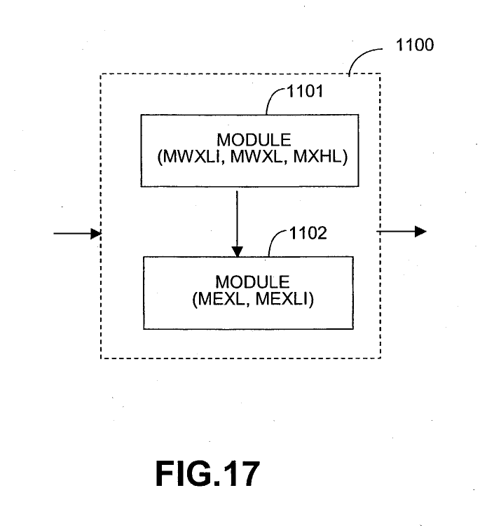

FIG. 17 shows one example of the exertion level estimate module 1100 of FIG. 8. The module 1100 includes modules 1101 and 1102.

The module 1101 estimates a maximal personal exertion level MWXI and a maximal personal exertion level index MWXLI based on work rate in accordance with (11.1.1)-(11.1.13) as set out below. The module 1102 estimates a maximal personal exertion level MEXL and a maximal personal exertion level index MEXLI based on energy requirement rate in accordance with (11.1.13.1)-(11.1.20) as set out below. When mETx is greater than “0”, the module 1102 executes its process.

The personal potential PE capacity estimate module 1200 of FIG. 8 is now described in detail.

Based on the current fitness profile, one's perception of maximal exertion and comparison of the measured mandatory performances one's potential is estimated. One's potential capacity is related to one's current capacity and the basic physical and physiological characteristics one has. The module 1200 evaluates all the relevant parameters provided by the previous modules to determine which the individual's potential is.

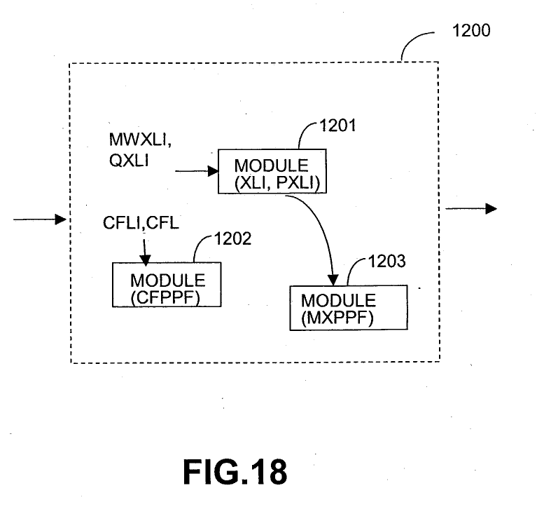

FIG. 18 shows one example of the personal potential p-e capacity estimate module 1200 of FIG. 8. The module 1200 includes modules 1201-1203. The module 1202 estimates an exertion level index XLI and a potential exertion level index PXLI of the individual based on the maximal personal exertion index MWXLI In accordance with (12.1.1)-(12.1.12) as set out below. The index XLI has a scalar value of one to ten. The module 1201 compares the XLI with the Index QXL to determine the PXLI.

The module 1202 estimates current performance potential fitness factor CFPPF based on the current fitness level index CFLI and the estimated current fat level CFL in accordance with (12.2.1)-(12.2.11) as set out below.

The module 1203 estimates a maximal exertion performance potential factor MXPPF based on the index PXLI in accordance with (12.3.1)-(12.3.10) as set out below.

The process assigns two factors CFPPF and MXPPF, which are used to estimate the potential and consequently the basis to design a training program.

The current and potential fitness parameters definition module 1300 of FIG. 8 is now described in detail. The module 1300 determines the values in terms of time, distance and progression of the training program to provide absolute real values related to the training program for the individual.

Using all indexes for current and potential performance capacity, the module 1300 transforms the PESE parameters into absolute meaningful values which can be translated into a desired training or fitness program for the individual.

In accordance with (13.1.1)-(13.1.16), the module 1300 outputs values of the variables PPKS, PP3MS, CFPPI, MXPPI, PPCF, PPC1KI, PPC3MI, WTPP1K, WTPP3M, PPI, PPEDD, PPEDc, PPPW, ETPP1K, ETPP3M and PPHR.

The module 1400 of FIG. 8 is now described in detail. The module 1400 estimates the relevant stair climb or graded treadmill performance parameters to determine ET1Kcx, WT3MScx, ET3MScx and Pwcx, PwK parameters in accordance with (14.1)-(14.3) as set out below.

The module 1500 of FIG. 8 is now described. The module 1500 estimates the basic work productive capacity of the individual and determines a Pw3M parameter in accordance with (15) set out below.

According to the embodiment of the present invention, the core processor 3 of FIG. 1 provides particular functions for providing specific personal estimation, such as the work of any performance in any class of physical activity, any external state and internal state, energy requirement per unit distance and duration for any class, external state and internal state, work productivity (work efficiency), and cardio-pulmonary energetics productivity (physiological efficiency). Further, the core processor provides physical fitness assessment on a universal scalar standard, personalized programs which addresses, but are not limited to, the areas of fitness training, fitness maintenance, weight control through exercise, and provides personal p-e potential and profile p-e capacity in specific classes.

According to the embodiment of the present invention, the equations of the PESE are derived from a single equation that is based upon the interrelationships between the basic variables of performance, and which integrates performance with energetics.

These mathematical relationships between the variables express the basic laws of performance-energetics. The variables are defined in universal scalar standards, which are independent of the age, gender or fitness level, any condition or fitness level in any class of physical activity (e.g. cycling, running, skating, swimming etc) under any external condition.

The core processor 3 applies individual information to the PESE. The values output from the core processor 3 are based upon the individual input information and do not rely on nor use standard statistical analyses of variation between samples or populations. Thus, the profile provided by the core processor 3 is unique for each person.

The performer obtains a personalized training schedule to achieve her/his potential most time effectively. Training and fitness programs, which maximizes his efforts to achieve his goal, can be easily created.

The system 10 of FIG. 1 achieves personalized-time-effectiveness due to: (1) its mathematical precision in estimating an individual's unique relationship between performance and energetics; (2) its capacity to utilize a single universal standard independent of age, gender and fitness and training level; (3) its accuracy in estimating an individual's current and potential performance-energetics capacity; (4) its flexibility of the rate of progression; (5) its precisely set personal potential target; and (5) its precise utilization of all mathematically expressed laws of performance-energetics.

The processed information is retrievable and new information can be inputted as training progresses.

The performance-energetics systems of equations (PESP), which are applied to the system 10 of FIG. 1, are now described in detail.

1 The input module 1:

1.1 Personal information input:

Birth date (age)

Name of performer (ID)

Gender (gend)

1.1.2 Anthropometric

Weight in pounds (bmp) or in kilograms (bmk),

Height in feet (htf) and in inches (hti) or in centimeters (htc) or in meters (htm)

Waist girth in inches (wai) or in centimeters(wac)

Hip girth in inches (hpi), or in centimeters (hpc).

Chest girth in inches (chi) or in centimeters (chc)

1.1.3 Performance.

1.1.3.1 Stair climb

1.1.3.1.1 If stair climb=yes then do:

1.1.3.1.2 Number of steps per flight (nstep)

1.1.3.1.3 Height of one step (hstepi) or in centimeters (hstepc)

1.1.3.1.4 Width of one step (wstepi) or in centimeters (wstepc)

1.1.3.1.5 Number of landings (nland)

1.1.3.1.6 Number of flights of stairs climbed (nflights)

1.1.3.1.7 Time of the performance in minutes (tminx) and seconds (tsecx)

1.1.3.2 Two walk-run outdoor 400 track measured performances

1.1.3.2.1 Distance of shorter performance in yards (dy1) or in meters (dm1) or in miles (dmi1) or in (dkm1)

1.1.3.2.2 The duration of the shorter performance in minutes. (tmin1) and in seconds (tsec1)

1.1.3.2.3 Distance of longer performance in yards (dy2) or in meters (dm2) or in miles (dmi2) or in (dkm2)

1.1.3.2.4 The duration of the loner performance in minutes (tmin2) and in seconds (tsec2)

1.1.3.3 Graded treadmill-walk or run.

1.1.3.3.1 Else do:

1.1.3.3.2 Percent grade of the treadmill (GX)

1.1.3.3.3 The speed setting of the treadmill in miles per hour (mphx) or kilometers per our (kmphx)

1.1.3.3.4 Duration of the performance in minutes (tminx) and seconds (tsecx)

1.1.3.4 Two horizontal treadmill measured performances.

1.1.3.3.1 Distance of shorter performance in miles per hour (mph1) or in kilometers per hour(kmph1)

1.1.3.4.2 The duration of the shorter performance in minutes (tmin1) and in seconds (tsec1)

1.1.3.4.3 Distance of longer performance in miles per hour (mph2) or in kilometers per hour(kmph2)

1.1.3.4.4 The duration of the loner performance in minutes (tmin2) and in seconds (tsec2).

1.1.3.4.5 END.

1.1.4 Physiological

1.1.4.1 Heart (pulse) rate

1.1.1.1.1 Basal heart rate (BHR)

1.1.1.1.2 Terminal performance heart rate of stair climb or graded treadmill walk or run (THRx)

1.1.1.1.3 Terminal heart of number one walk-run performance (THR1)

1.1.1.1.4 Terminal heart of number two walk-run performance (THR2)

1.1.4.2 Oxygen uptake:

1.1.4.2.1 Peak minute volume rate (liters per minute) of oxygen for all treadmill performances (vopkx,vopk1 and vopk2)

2. The transformation module 2:

2.1 Anthropometrical:

2.1.1 Factor pounds to kilograms: bmkF=0.45359237

2.1.2 Factor feet to meters; fmF=0.3048

2.1.3 Factor inches to meters; imF=0.0254

2.1.4 Factor inches to centimeters. (icmF=2.54)

2.1.4.1 IF bmp≠0 then do:

2.1.4.2 bmk=bmp*bmkF

2.1.4.3 htm=(htf*fmF)+(hti*imF)

2.1.4.4 wac=wai*icmF

2.1.4.5 hpc=hpi*icmF

2.1.4.6 chc=chi*icmF

2.2 Body mass indexes:

2.1.1 BMI=bmk÷htm²

2.1.2 WHR=wac÷hpc

2.1.3 CWD=chc−wac

2.3 Gender Factor:

2.3.1 If gend=M then GF=1

2.3.2 Else if gend=F then GF=0.75

2.4 Stair climb:

2.4.1 Factor to trasform centimeters to meters: (cmF=0.01)

2.4.2 Factor to transform meters to kilometers (mtkmF=0.001).

2.4.3 Factor to calculate landings to horizontal distance. (ldhF=1.5)

2.4.4 Vertical distance conditional estimate of stair climb:

2.4.4.1 If stair climb then do:

2.4.4.2 If hstepi then do:

2.4.4.3 dvm=nstep*hstepi*nflights*imF

2.4.4.4 Else do:

2.4.4.5 dvm=nstep*hstepc* nflights*cmF. END

2.4.5 Horizontal distance conditional estimate of stair climb:

2.4.5.1 landh=nland*ldhF

2.4.5.2 IF wstepi≠0 then do

2.4.5.3 dhm=nstep*wstepi*imF*nflight

2.4.5.4 Else do:

2.4.5.5 dhm=nstep*wstepc*cmF*nflight

2.4.5.6 END.

2.4.5.7 dkmx=(dhm+landh )*mtkmF

2.4.5.8 END.

2.5 Walk-run outdoor 400 m track performances:

2.5.1 Distance and duration of #1 (shorter performance):

2.5.1.1 If dy1 or dmi1≠0 then do:

2.5.1.2 d1=(dy1*ykmF)+(dmi1*mikmF)

2.5.1.3 Else do:

2.5.1.4 d1=(dm1*mtkmF)+dkm1 END.

2.5.1.5 th1=(tmin1*mhF)+(tsec1*shF)

2.5.1.6 END

2.5.2 Distance duration of #2 (longer) performance:

2.5.2.1 If dy2 or dmi2≠0 then do:

2.5.2.2 d2=(dy2*ykmF)+(dmi2*mikmF)

2.5.2.3 Else do:

2.5.2.4 d2=(dm2*mtkmF)+dkm2 END.

2.5.2.5 th2=(tmin2*mhF)+(tsec2*shF).

2.5.2.6 END.

2.6 Graded treadmill performance:

2.6.1 Factor miles to kilometers (mikmF=1.609344).

2.6.2 Factor yards to kilometers (ykmF=0.0009144)

2.6.3 Factor minutes to hours (mhF=0.01666667)

2.6.4 Factor seconds to hours (shF=0.0002777778):

2.6.4.1 Else If TMR is selected then do:

2.6.4.2 mthx=tminx*mhF

2.6.4.3 sthx=tsecx*shF

2.6.4.4 thx=mthx+sthx

2.6.4.5 sin=sin Θ(Gx/100). NB. The factor (function) to calculate horizontal distance is sin=sin Θ(Gx/100). However converting sine θ of the grade Gx/100 is more accurate approximately 44 centimeters in 65 meters.

2.6.4.6 If mphx≠0 then do

2.6.4.7 dgkm=mphx*thx*mikmF

2.6.4.8 dgm=dgkm×1000

2.6.4.9 dvm=dgm*sin

2.6.4.0 dhm=sqrt(dgm\hat{ }2−dvm\hat{ }2)

2.6.4.11 dkmx=dhm×mtkmF END

2.6.4.12 Else do

2.6.4.13 dgkm=kmphx*thx

2.6.4.14 dgm=dgkm×1000

2.6.4.15 dvm=dgm*sin

2.6.4.16 dhm=sqrt(dgm\hat{ }2−dvm\hat{ }2)

2.6.4.17 dkmx=dhm*mtkmF END.

2.6.4.18 END.

2.7 Horizontal treadmill performances:

2.7.1 Short and long duration of #1 and #2 TMR

2.7.1.1 th1=(tmin1*mhF)+(tsec1*shF)

2.7.1.2 th2=(tmin2*mhF)+(tsec2*shF)

2.7.2 Short and long distance of #1 and #2 TMR

2.7.2.1 If mph1≠0 then do:

2.7.2.2 dmi1=mph1*th1

2.7.2.3 d1=(dmi1*mikmF) END

2.7.2.4 Else do:

2.7.2.5 dmi2=mph2*th2

2.7.2.6 d2=(dmi2*mikmF) END.

END:

2.8 Defines basic PESE parameters:

2.8.1 Define the mean speed of the three measured performances.

2.8.1.1 sₓ=dkmx÷thx

2.8.1.2 s₁=d1÷th1

2.8.1.3 s₂=d2÷th2

2.8.2 Define distance and duration parameters of the three measured performances:

2.8.2.1 Dₓ=1÷dkmx

2.8.2.2 D₁=1÷d1

2.8.2.3 D₂=1÷d2

2.8.2.4 Tₓ=1÷thx

2.8.2.5 T₁=1÷th1

2.8.2.6 T₂=1÷th2

2.9 Energetics:

2.9.1 Work expenditure:

2.9.1.1 mkgkcal=427;

2.9.1.2 MWtm=(dvm*bmk)/mkgkcal

2.9.1.3 mWₓ=MWtm

2.9.1.4 Else do MWsc=(dvm*bmk)/mkgkcal)

2.9.1.5 mWₓ=MWsc END

2.9.2 Heart rate reserve:

2.9.2.1 hrrx=THRx−BHR

2.9.2.2 hrr1=THR1−BHR

2.9.2.3 hrr2=THR2−BHR

2.9.3 Energy requirement (VO2 liters per minute):

2.9.3.1 Factor to convert VO2 to kcal: Kcal=5.0

2.9.3.2 mETx=vopkx×Kcal

2.9.3.3 mET1=vopk1×Kcal

2.9.3.4 mET2=vopk2×Kcal

3. The body mass parameter definitions and classifications module 300:

3.1 Body mass fitness level index (BMFLI):

3.1.1 If gend=M then do:

3.1.2 If BMI≦18 then BMFLI=10

3.1.3 If BMI>18 and ≦23 then BMFLI=9

3.1.4 If BMI>23 and ≦24 then BMFLI=8

3.1.5 If BMI>24 and ≦25 then BMFLI=7

3.1.6 If BMI>25 and ≦26 then BMFLI=6

3.1.7 If BMI>26 and ≦27 then BMFLI=5

3.1.8 If BMI>27 and ≦28 then BMFLI=4

3.1.9 If BMI>28 and ≦29 then BMFLI=3

3.1.10 If BMI>29 and ≦30 then BMFLI=2

3.1.11 If BMI>30 then BMFLI=1

3.1.12 Else if gend=F then do:

3.1.13 If BMI≦17 then BMFLI=10

3.1.14 If BMI>17 and ≦22 then BMFLI=9

3.1.15 If BMI>22 and ≦23 then BMFLI=8

3.1.16 If BMI>23 and ≦24 then BMFLI=7

3.1.17 If BMI>24 and ≦25 then BMFLI=6

3.1.18 If BMI>25 and ≦26 then BMFLI=5

3.1.19 If BMI>26 and ≦27 then BMFLI=4

3.1.20 If BMI>27 and ≦28 then BMFLI=3

3.1.21 If BMI>28 and ≦29 then BMFLI=2

3.1.22 If BMI>29 then BMFLI=1 END.

3.2 Fit body mass (BFM):

3.2.1 If gend=F and age≧19 and ≦34 then do:

3.2.2 BFM=(htm×66.47)−57.56

3.2.3 Else If gend=F and age≧35 and ≦49 then do:

3.2.4 BFM=(htm×70.40)−59.91

3.2.5 Else If gend=F and age≧50 and ≦69 then do:

3.2.6 BFM=(htm×76.39)−64.01

3.2.7 Else If gend=F and age≧70 do:

3.2.8 BFM=(htm×81.35)−67.69

3.2.9 Else if gend=M and age≧19 and ≦34 then do:

3.2.10 BFM=(htm×84.33)−69.80

3.2.11 Else If gend=M and age≧35 and ≦49 then do:

3.2.12 BFM=(htm×93.26)−77.33

3.2.13 Else If gend=M and age≧50 and ≦69 then do:

3.2.14 BFM=(htm×95.24)−79.08

3.2.15 Else If gend=M and age≧70 do:

3.2.16 BFM=(htm×101)−84.67

3.2.17 Else if age ≦19 then do:

3.2.18 BFM=(htm×66.67)−57.572 END

3.3 Body fit mass index (BFMI):

3.3.1. FBMD=bmk−BFM

3.3.2. If FBMD≦0 then do

3.3.3 BFMI=10

3.3.4 Else If FBMD≧0 and <1 then do

3.3.5 BFMI=9

3.3.6 Else If FBMD≧1 and <3 then do

3.3.7 BFMI=8

3.3.8 Else If FBMD≧3 and <6 then do

3.3.9 BFMI=7

3.3.10 Else If FBMD≧6 and <10 then do

3.3.11 BFMI=6

3.3.12 Else If FBMD≧10 and <15 then do

3.3.13 BFMI=5

3.3.14 Else If FBMD≧15 and <20 then do

3.3.15 BFMI=4

3.3.16 Else If FBMD≧20 and <25 then do

3.3.17 BFMI=3

3.3.18 Else If FBMD≧25 and <30 then do

3.3.19 BFMI=2

3.3.20 Else If FBMD≧30 the do

3.3.21 BFMI=1 END

3.4 Male waist-hip factor index (WHFI).

3.4.1 If gend=M and age >30 and ≦60 then do:

3.4.2 If WHR≦0.57 then WHFI=10

3.4.3 If WHR≦0.62 and >0.57 then WHFI=9

3.4.4 If WHR≦0.67 and >0.62 then WHFI=8

3.4.5 If WHR≦0.72 and >0.67 then WHFI=7

3.4.6 If WHR≦0.77 and >0.72 then WHFI=6

3.4.7 If WHR≦0.82 and >0.77 then WHFI=5

3.4.8 If WHR≦0.87 and >0.82 then WHFI=4

3.4.9 If WHR≦0.92 and >0.87 then WHFI=3

3.4.10 If WHR≦1.00 and >0.92 then WHFI=2

3.4.11 If WHR>1.00 then WHFI=1

3.4.12 Else if gend=M and age >60 then do

3.4.13 If WHR≦0.59 then WHFI=10

3.4.14 If WHR≦0.64 and >0.59 then WHFI=9

3.4.15 If WHR≦0.69 and >0.64 then WHFI=8

3.4.16 If WHR≦0.74 and >0.69 then WHFI=7

3.4.17 If WHR≦0.79 and >0.74 then WHFI=6

3.4.18 If WHR≦0.84 and >0.79 then WHFI=5

3.4.19 If WHR≦0.90 and >0.84 then WHFI=4

3.4.20 If WHR≦0.95 and >0.90 then WHFI=3

3.4.21 If WHR≦0.98 and >0.95 then WHFI=2

3.4.22 If WHR≦1.03 then WHFI=1 END

3.5 Female waist-hip factor index (WHFI):

3.5.1 If gend=F and age >30 and ≦60 then do:

3.5.2 If WHR≦0.37 then WHFI=10

3.5.3 If WHR<0.42 and >0.37 then WHFI=9

3.5.4 If WHR≦0.47 and >0.42 then WHFI=8

3.5.5 If WHR≦0.52 and >0.47 then WHFI=7

3.5.6 If WHR≦0.57 and >0.52 then WHFI=6

3.5.7 If WHR≦0.62 and >0.57 then WHFI=5

3.5.8 If WHR≦0.67 and >0.62 then WHFI=4

3.5.9 If WHR≦0.72 and >0.67 then WHFI=3

3.5.10 If WHR≦0.8 and >0.72 then WHFI=2

3.5.11 If WHR>0.82 then WHFI=1

3.5.12 Else if gend=F and age >60 then do:

3.5.13 If WHR≦0.38 then WHFI=10

3.5.14 If WHR≦0.42 and >0.38 then WHFI=9

3.5.15 If WHR≦0.47 and >0.42 then WHFI=8

3.5.16 If WHR≦0.51 and >0.47 then WHFI=7

3.5.17 If WHR≦0.56 and >0.51 then WHFI=6

3.5.18 If WHR≦0.60 and >0.56 then WHFI=5

3.5.19 If WHR≦0.65 and >0.60 then WHFI=4

3.5.20 If WHR≦0.72 and >0.65 then WHFI=3

3.5.21 If WHR≦0.8 and >0.72 then WHFI=2

3.5.22 If WHR>0.9 then WHFI=1 END

3.6 Chest-waist body fat Index (XBFI):

3.6.1 DCB=12−CWD

3.6.2 XBF=0.457+(DCB×0.758)

3.6.3 If XBF≦1 then XBFI=10

3.6.4 If XBF≦2 then XBFI=9

3.6.5 If XBF≦3 then XBFI=8

3.6.6 If XBF≦4 then XBFI=7

3.6.7 If XBF≦5 then XBFI=6

3.6.8 If XBF≦6 then XBFI=5

3.6.9 If XBF≦7 then XBFI=4

3.6.10 If XBF≦8 then XBFI=3

3.6.11 If XBF≦9 then XBFI=2

3.6.12 If XBF≦10 then XBFI=1

3.7 Percent body fat factor (PBFF):

3.7.1 If BMI≧19 and <22 then do

3.7.2 PBFF=10

3.7.3 If BMI≧22 and <23 then do

3.7.4 PBFF=9

3.7.5 If BMI≧23 and <24 then do

3.7.6 PBFF=8

3.7.7 If BMI≧24 and <26 then do

3.7.8 PBFF=7

3.7.9 If BMI≧26 and <28 then do

3.7.10 PBFF=6

3.7.11 If BMI≧28 and <30 then do

3.7.12 PBFF=5

3.7.13 If BMI≧30 and <32 then do

3.7.14 PBFF=4

3.7.15 If BMI≧32 and <34 then do

3.7.16 PBFF=3

3.7.17. If BMI≧34 and <36 then do

3.7.18 PBFF=2

3.7.19 If BMI≧36 then do

3.7.20 PBFF=1 END

3.8 Current body fat (CPF):

3.8.1 CBMBFI=(BMFLI+BFMI)÷2:

3.8.2 IF CBMBFI≧9 and ≦10 then CPF=1

3.8.3 IF CBMBFI≧8 and <9 then CPF=2

3.8.4 IF CBMBFI≧7 and <8 then CPF=3

3.8.5 IF CBMBFI≧6 and <7 then CPF=4

3.8.6 IF CBMBFI≧5 and <6 then CPF=5

3.8.7 IF CBMBFI≧4 and <5 then CPF=6

3.8.8 IF CBMBFI≧3 and <4 then CPF=7

3.8.9 IF CBMBFI≧2 and <3 then CPF=8

3.8.10 IF CBMBFI≧0 and <1 then CPF=9

3.8.11 IF CBMBFI<0 then CPF=10 END

3.9 Current fat factor (CFF):

3.9.1 PBFI=((WHFI+XBFI+PBFF)÷3

3.9.2 IF PBFI≧1 and <2 then CFF=10

3.9.3 IF PBFI≧2 and <3 then CFF=9

3.9.4 IF PBFI≧3 and <4 then CFF=8

3.9.5 IF PBFI≧4 and <5 then CFF=7

3.9.6 IF PBFI≧5 and <6 then CFF=6

3.9.7 IF PBFI≧6 and <7 then CFF=5

3.9.8 IF PBFI≧7 and <8 then CFF=4

3.9.9 IF PBFI≧8 and <9 then CFF=3

3.9.10 IF PBFI≧9 and <10 then CFF=2

3.9.11 IF PBFI≧10 then CFF=1 END

3.10 Current fat level (CFL):

3.10.1 CFL=(CFF+CPF)÷2

4. Performance assessment and classification:

4.1 Interclass performance factor (ICPsF):

4.1.1 If CmP=1 then do:

4.1.2 ICPsF=2.420

4.1.3 If CmP=2 then do:

4.1.4 ICPsF=1.755

4.1.5 If CmP=3 then do:

4.1.6 ICPsF=1.142

4.1.7 If CmP=4 then do:

4.1.8 ICPsF=1.0

4.1.9 If CmP=5 then do:

4.1.10 ICPsF=0.918

4.1.11 If CmP=6 then do:

4.1.12 ICPsF=0.642

4.1.13 If CmP=7 then do:

4.1.14 ICPsF=0.564

4.1.15 If CmP=8 then do:

4.1.16 ICPsF=0.199

4.1.17 If CmP=9 then do:

4.1.18 ICPsF=0.191

4.1.19 If CmP=10 then do:

4.1.20 ICPsF=0.183

4.1.21 If CmP=11 then do:

4.1.22 ICPsF=0.173 END

4.2 Interclass Energetics factor (ICPwF):

4.2.1 If CmP=1 then do:

4.2.2 ICPwF=0.413

4.2.3 If CmP=2 then do:

4.2.4 ICPwF=0.570

4.2.5 If CmP=3 then do:

4.2.6 ICPwF=0.875

4.2.7 If CmP=4 then do:

4.2.8 ICPwF=1.0

4.2.9 If CmP=5 then do:

4.2.10 ICPwF=1.089

4.2.11 If CmP=6 then do:

4.2.12 ICPwF=1.567

4.2.13 If CmP=7 then do:

4.2.14 ICPwF=1.773

4.2.15 If CmP=8 then do:

4.2.16 ICPwF=5.025

4.2.17 If CmP=9 then do:

4.2.18 ICPwF=5.238

4.2.19 If CmP=10 then do:

4.2.20 ICPwF=5.469

4.2.21 If CmP=11 then do:

4.2.22 ICPwF=5.795. END

4.3 Defines age class speed factor (ACsF):

4.3.1 If age≧10 and <15 then do:

4.3.2 ACsF=0.63

4.3.3 If age≧15 and <20 then do:

4.3.4 ACsF=0.844

4.3.5 If age≧20 and <25 then do:

4.3.6 ACsF=0.937

4.3.7 If age≧25 and <30 then do:

4.3.8 1ACsF=0.985

4.3.9 If age≧30 and <35 then do:

4.3.10 ACsF=1.0

4.3.11 If age≧35 and <40 then do:

4.3.12 ACsF=0.979

4.3.13 If age≧40 and <45 then do:

4.3.14 ACsF=0.938

4.3.15 If age≧45 and <50 then do:

4.3.16 ACsF=0.903

4.3.17 If age≧50 and <55 then do:

4.3.18 ACsF=0.868

4.3.19 If age≧55 and <60 then do:

4.3.20 ACsF=0.829

4.3.21 If age≧60 and <65 then do:

4.3.22 ACsF=0.799

4.3.23 If age≧65 and <70 then do:

4.3.24 ACsF=0.763

4.3.25 If age≧70 and <75 then do:

4.3.26 ACsF=0.717

4.3.27 If age≧75 and <80 then do:

4.3.28 ACsF=0.667

4.3.29 If age≧80 and <85 then do:

4.3.30 ACsF=0.605

4.3.31 If age≧85 and <90 then do:

4.3.32 ACsF=0.542

4.3.33 If age≧90 and <95 then do:

4.3.34 ACsF=0.448

4.3.35 If age≧95 and <100 then do:

4.3.36 ACsF=0.32

4.3.37 If age≧100 then do:

4.3.38 ACsF=0.15 END

4.4 Defines age class heart rate reserve (PHRR):

4.4.1 If age≧10 and <15 then do:

4.4.2 PHRR=106×GF

4.4.3 If age≧15 and <20 then do:

4.4.4 PHRR=142×GF

4.4.5 If age≧20 and <25 then do:

4.4.6 PHRR=158×GF

4.4.7 If age≧25 and <30 then do:

4.4.8 PHRR=166×GF

4.4.9 If age≧30 and <35 then do:

4.4.10 PHRR=168×GF

4.4.11 If age≧35 and <40 then do:

4.4.12 PHRR=165×GF

4.4.13 If age≧40 and <45 then do:

4.4.14 PHRR=158×GF

4.4.15 If age≧45 and <50 then do:

4.4.16 PHRR=152×GF

4.4.17 If age≧50 and <55 then do:

4.4.18 PHRR=146×GF

4.4.19 If age≧55 and <60 then do:

4.4.20 PHRR=140×GF

4.4.21 If age≧60 and <65 then do:

4.4.22 PHRR=134×GF

4.4.23 If age≧65 and <70 then do:

4.4.24 PHRR=128×GF

4.4.25 If age≧70 and <75 then do:

4.4.26 PHRR=120×GF

4.4.27 If age≧75 and <80 then do:

4.4.28 PHRR=112×GF

4.4.29 If age≧80 and <85 then do:

4.4.30 PHRR=102×GF

4.4.31 If age≧85 and <90 then do:

4.4.32 PHRR=91×GF

4.4.33 If age≧90 and <95 then do:

4.4.34 PHRR=75×GF

4.4.35 If age≧95 and <100 then do:

4.4.36 PHRR=54×GF

4.4.37 If age≧100 then do:

4.4.38 PHRR=25×GF END

4.5 Defines age class Energetics capacity (PETC):

4.5.1 If age≧10 and <15 then do:

4.5.2 PETC=1026×GF

4.5.3 If age≧15 and <20 then do:

4.5.4 PETC=1375×GF

4.5.5 If age≧20 and <25 then do:

4.5.6 PETC=1526×GF

4.5.7 If age≧25 and <30 then do:

4.5.8 PETC=1604×GF

4.5.9 If age≧30 and <35 then do:

4.5.10 PETC=1628×GF

4.5.11 If age≧35 and <40 then do:

4.5.12 PETC=1594×GF

4.5.13 If age≧40 and <45 then do:

4.5.14 PETC=1528×GF

4.5.15 If age≧45 and <50 then do:

4.5.16 PETC=1470×GF

4.5.17 If age≧50 and <55 then do:

4.5.18 PETC=1414×GF

4.5.19 If age≧55 and <60 then do:

4.5.20 PETC=1350×GF

4.5.21 If age≧60 and <65 then do:

4.5.22 PETC=1301×GF

4.5.23 If age≧265 and <70 then do:

4.5.24 PETC=1243×GF

4.5.25 If age≧70 and <75 then do:

4.5.26 PETC=1167×GF

4.5.27 If age≧75 and <80 then do:

4.5.28 PETC=1086×GF

4.5.29 If age≧80 and <85 then do:

4.5.30 PETC=985×GF

4.5.31 If age≧85 and <90 then do:

4.5.32 PETC=883×GF

4.5.33 If age≧90 and <95 then do:

4.5.34 PETC=730×GF

4.5.35 If age≧95 and <100 then do:

4.5.36 PETC 520×GF

4.5.37 If age≧100 then do:

4.5.38 PETC=244×GF END

5. Universal standards estimate:

5.1 Defines age-gender-distance-class performance standard (P1KS):

5.1.1 1K30=29.9591

5.1.2 P1KS=ACsF×1K30×ICPsF×GF

5.2 Defines age-gender-time-class performance standard (P3MS):

5.2.1 3M30=29.04

5.2.2 P3MS=ACsF×3M30×ICPsF×GF

5.3 Defines standards parameters:

5.3.1 D1KS=1

5.3.2 T3MS=20

5.3.3 T3MSx=20

5.3.4 PD1KS=1

5.3.5 PT1KS=P1KS

5.3.6 PT3MS=20

5.3.7 UT3M=20

5.3.8 UTKS=1K30

6 Personal standard assessment and classification:

6.1 Defines profile slope:

6.1.1 m=(s1−s2)÷(T1−T2)

6.1.2 Pm=(P1KS−P3MS)÷(PT1KS−PT3MS)

6.1.3 Um=(1K30−3M30)÷(UTKS−PT3MS)

6.2 Defines profile intercepts of measured class performances:

6.2.1 b=s1−(m×T1)

6.2.2 Pb=P1KS−(Pm×PT1KS)

6.2.3 Ub=1K30−(Um×UTKS)

6.3 Defines basic personal standards:

6.3.1 If s1>20 then do: 1KS=b÷(1−m):

6.3.2 Else do: 1KS=−b÷(m−1): END

6.3.3 3MS=b+(m×T3MS)

6.3.4 3MSx=T3MS÷Dx

6.3.5 1KSx=(1KS×3MSx)/3MS

6.4 Defines relevant universal and personal standards:

6.4.1 T1KS=1KS

6.4.2 rsK=√(D1KS\hat{ }²+T1KS²)

6.4.3 rsPK=√(PT1KS²+PD1KS²)

6.4.4 rsUKS=√(1K30²+PD1KS²)

6.4.5 RPKS=rsK×100÷rsPK

6.4.6 RUKS=rsK×100÷rsUKS

6.4.7 rs3M=√(T3MS\hat{ }²+D3MS²)

6.4.8 D3MS=T3MS÷3MS

6.4.9 d3MS=1÷D3MS

6.4.10 PD3MS=PT3MS÷P3MS

6.4.11 Pd3MS=1÷PD3MS

6.4.12 Rd3MS=d3MS×100÷Pd3MS

6.4.13 rsP3M=√(PT3MS²+PD3MS²)

6.4.14 RP3MS=(rs3M×100)÷rsP3M

6.4.15 UD3MS=PT3MS÷3M30

6.4.16 Ud3MS=1÷UD3MS

6.4.17 RdU3MS=d3MS×100÷Ud3MS

6.4.18 rsU3MS=√(PT3MS²+Ud3MS²)

6.4.19 RU3MS=(rs3M×100)÷rsU3MS

6.4.20 RrsKM=rsK/rs3M

7. Work parameter estimates:

7.1 Basic work parameter estimates:

7.1.1 WDx=mWₓ×Dx

7.1.2 WTx=WDx×sx

7.2 Iteration loop to estimate 3WDc:

7.2.1 Iterational factor=0.001

7.2.2 Xs=(Iterational variable starts with a value of 0.001

7.2.3 XWT=Xs×WDx

7.2.4 CWD=XWT/3MS

7.2.5 AWD=WDx+CWD

7.2.6 As=XWT*AWD

7.2.7 MCs=sx

7.2.7 MCWT=MCs/CWD

7.2.8 MWT=WTx*MCWT

7.2.9 Ms=MWT/AWD

7.2.10 Es=MWT+CWD

7.2.11 Aslog=ln(Es) i.e. the logarithm of the variable Es to the base e

7.2.12 Limiting conditional variables

7.2.13 If stair climb performance then stop iteration when Es−Eslog=0.000

7.2.14 Else stop iteration when sx−As=0.000

7.3 Defines walk-run class work rate parameters:

7.3.1 WDc=CWD

7.3.2 WDcx=WDx+WDc

7.3.3 WT1=WDc×s1

7.3.4 WT2=WDc×s2

7.3.5 WT1KS=WDc×1KS

7.3.6 WT3MS=WDc×3MS

7.3.7 bmWDc=WDc÷bmk

7.3.8 bmWDx=WDx÷bmk

7.4 Defines the grade and work per grade of X performance:

7.4.1 GX=dvm/dhm

7.4.2 WGX=(WDx+WDc)÷GX

7.5 Defines the work of each type in iteration:

7.5.1 DX=T3MS/Xs

7.5.2 DA=T3MS/As

7.5.3 DM=Tx/Ms

7.5.4 DE=Tx/Es

7.5.5 WX=WDx/Dx

7.5.6 WC=WDc/D3MS

7.5.7 WA=WDx/D3MS

7.5.8 WM=AWD/Dx

7.5.9 WE=WDc/DE

7.6 Defines the speed—WD ratios of work estimates:

7.6.1 RsCE=Cs/Es

7.6.2 RsAM=As/Ms

7.6.3 RWAC=AWD/CWD

7.6.4 RWME=AWD/WDc

7.7 Defines radius vectors of work standards:

7.7.1 rsWK=√(WT1KS²+WDc²)

7.7.2 rsW3M=√(WT3MS²+WDc²)

7.7.3 RrsWKM=rsWK/rsW3M

8 Heart rate reserve (HRR) parameters defined:

8.1 Defines the key variables (HRDx):

8.1.1 HRDx=hrrx÷sx

8.1.2 HRTKx=HRDx×1KSx

8.2.2 HRT3Mx=HRDx×3MSx

8.2 Defines relevant parameters:

8.2.1 HRRD1=hrr1÷s1

8.2.2 HRRD2=hrr2÷s2

8.2.3 HRD1=HRRD1÷s1

8.2.4 HRD2=HRRD2÷s2

8.2.5 HRDc=HRD1+HRD2)÷2

8.2.6 HRTKc=HRDc×1KS

8.2.7 HRT3Mc=HRDc×3MS

8.7.8 RHRT=HRT3Mc*100/PHRR

8.3 Defines WPa parameter for 1KS 3MS standard:

8.3.1 WPa3=HRDc×3MS

8.3.2 WPaK=HRDc×1KS

9 Conditional A. ( ) Energy requirement module:

9.1 Estimate energy requirement ED parameter:

9.1.1 If mETx≠0 and mET1 or mET2≠0, Then do;

9.1.2 Ex=mETx×thx×60

9.1.3 E1=mET1×th1×60

9.1.4 E2=mET2×thx2×60

9.1.5 EDcx=Ex×Dx

9.1.6 EDc1=E1×D1

9.1.7 Edc2=Ex2×D2

9.1.8 mEDc=(EDc1+EDc2)/2

9.1.9 wEDc=(EDcx*WDc)/WDcx

9.1.10 EDc=(mEDc+wEDc)/2.

9.2 Estimate relevant E parameters:

9.2.1 ETx=EDcx×sx

9.2.2 ET1=EDc×s1

9.2.3 ET2=EDc×s2

9.2.4 bmEDx=EDx÷bmk

9.2.5 DiffET=ET1−ET2

9.2.6 ET1KS=EDc×1KS

9.2.7 ET3MS=EDc×3MS

9.2.8 rsEK=√(ET1KS²+EDC²)

9.2.9 rsE3M=√(ET3MS²+EDC²)

9.2.10 RrsEKM=rsEK/rsE3MS

9.2.11 RETc=ET3MS×100÷PETC

9.3 Define Pwx, Pwc and Pa parameters:

9.3.1 Pwcx=WDcx÷EDcx

9.3.2 Pwc=WDc÷EDc

9.3.3 Pa=ET3MS÷HRT3Mc

9.3.4 END.

10 Conditional B. (If mETx=0) Energetics module:

10.1 Defines Pw and Pa parameters:

10.1.1 IF CPF≧9 and ≦10 then Pw=0.22 and Pa=21

10.1.2 IF CPF≧8 and <9 then Pw=0.20 and Pa=18

10.1.3 IF CPF≧7 and <8 then Pw=0.18 and Pa=16

10.1.4 IF CPF≧6 and <7 then Pw=0.16 and Pa=13

10.1.5 IF CPF≧5 and <6 then Pw=0.14 and Pa=11

10.1.6 IF CPF≧4 and <5 then Pw=0.12 and Pa=8

10.1.7 IF CPF≧3 and <4 then Pw=0.10 and Pa=6

10.1.8 IF CPF≧2 and <3 then Pw=0.08 and Pa=5

10.1.9 IF CPF≧1 and <2 then Pw=0.05 and Pa=3

10.1.10 IF CPF≧0 and <1 then Pw=0.02 and Pa=1

10.2 Defines relevant parameters:

10.2.1 EDPw=WDc÷Pw

10.2.2 ETPw=EDPw×1KS

10.2.3 ETPa=HRTKc×Pa

10.2.4 ETc=(ETPa+ETPw)÷2

10.2.5 EDc=ETc÷1KS

10.2.6 EDx=WDx/Pw

10.2.7 ET1KSx=EDx*1KSx

10.2.8 ETx=EDx×sx

10.2.9 ET1=EDc×s1

10.2.10 ET2=EDc×s2

10.2.11 ETK=1KS×EDc

10.2.12 ET3MS=3MS×EDc

10.3 Re-estimate Pw and Pa parameters:

10.3.1 Pwc=WDc÷EDc

10.3.2 Pwx=WDₓ÷EDx

10.3.3 Pax=ETx÷HRTKx

10.3.4 Pac=ETK÷HRTKc END

11 Estimate personal exertion levels:

11.1 Defines maximal personal exertion index based on work rate (MWXLI):

11.1.1 RHR1=HRRD1/HRT3Mc

11.1.2 RHR2=HRRD2/HRT3Mc

11.1.3 RHR=HRT3Mc÷PHRR

11.1.4 PHR3MS=HRDc×P3MS

11.1.5 PRHR=HRT3Mc×100÷PHR3MS

11.1.6 PPHRMX=PHRR*100/PHR3MS

11.1.7 MHXL=(RHR1+RHR2+RHR+PRHR)÷4

11.1.8 RWT13MS=WT1÷WT3MS

11.1.9 RWT23MS=WT2÷WT3MS

11.1.10 PWT3MS=WDc×P3MS

11.1.11 PRWT=WT3MS÷PWT3MS

11.1.12 MWXL=(RWT13MS+RWT23MS+PRWT)÷3.

11.1.13 MWXLI=(MHXL+MWXL)÷2

11.1.13.1 Conditional (if mETx>0) definition of maximal personal exertion based on energy requirement rate (MEXLI).

11.1.14 RET13MS=ET1÷ET3MS

11.1.15 RET23MS=ET2÷ET3MS

11.1.16 PET3MS=EDc×P3MS

11.1.17 RET=ET3MS÷PETC

11.1.18 PRET=ET3MS÷PET3MS

11.1.19 MEXL=(RET13MS+RET23MS+RET+PRET)÷4

11.1.20 MEXLI=(MHXL+MEXL)÷2 END

12 Estimate personal potenetial P-E capacity:

12.1 Estimates Exertion Level Index (XLI):

12.1.1 If MWXLI≧0.9 and ≦1 then do XLI=10

12.1.2 If MWXLI≧0.8 and <0.9 then do XLI=9

12.1.3 If MWXLI≧0.7 and <0.8 then do XLI=8

12.1.4 If MWXLI≧0.6 and <0.7 then do XLI=7

12.1.5 If MWXLI≧0.5 and <0.6 then do XLI=6

12.1.6 If MWXLI≧0.4 and <0.5 then do XLI=5

12.1.7 If MWXLI≧0.03 and <0.4 then do XLI=4

12.1.8 If MWXLI≧0.2 and <0.3 then do XLI=3

12.1.9 If MWXLI≧0.1 and <0.2 then do XLI=2

12.1.10 If MWXLI<0.1 then do XLI=1 END

12.1.11 If XLI≧QXLI then let PXLI=XLI

12.1.12 Else if XLI<QXLI then let PXLI=QXLI END

12.2 Estimates current performance potential fitness factor (CFPPF):

12.2.1 CPCF=(CFLI+CFL)÷2

12.2.2 IF CPCF=1 and <2 then do CFPPF=22.1

12.2.3 IF CPCF=2 and <3 then do CFPPF=16.0

12.2.4 IF CPCF=3 and <4 then do CFPPF=11.4

12.2.5 IF CPCF=4 and <5 then do CFPPF=8.0

12.2.6 IF CPCF=5 and <6 then do CFPPF=5.3

12.2.7 IF CPCF=6 and <7 then do CFPPF=3.2

12.2.8 IF CPCF=7 and <8 then do CFPPF=1.8

12.2.9 IF CPCF=8 and <9 then do CFPPF=0.9

12.2.10 IF CPCF=9 and <10 then do CFPPF=0.3

12.2.11 IF CPCF=>10 then do CFPPF=0 END

12.3 Estimates maximal exertion performance potential factor (MXPPF):

12.3.1 IF PXLI=1 then do MXPPF=22.1

12.3.2 IF PXLI=2 then do MXPPF=16.0

12.3.3 IF PXLI=3 then do MXPPF=11.4

12.3.4 IF PXLI=4 then do MXPPF=8.0

12.3.5 IF PXLI=5 then do MXPPF=5.3

12.3.6 IF PXLI=6 then do MXPPF=3.2

12.3.7 IF PXLI=7 then do MXPPF=1.8

12.3.8 IF PXLI=8 then do MXPPF=0.9

12.3.9 IF PXLI=9 then do MXPPF=0.3

12.3.10 IF PXLI=10 then do MXPPF=0 END

13 Defines current and potential fitness parameters:

13.1.1 PPKS=1KS×100÷P1KS

13.1.2 PP3MS=d3MS×100÷Pd3MS

13.1.3 CFPPI=CFPPF/100

13.1.4 MXPPI=(MXPPF÷100)

13.1.5 PPCF=CFPPI+MXPPI+1

13.1.6 PPC1KI=PPCF×1KS

13.1.7 PPC3MI=PPCF×3MS

13.1.8 WTPP1K=WDc×PPC1KI

13.1.9 WTPP3M=WDc×PPC3MI

13.1.10 PPI=PPCF−1

13.1.11 PPEDD=1−PPI

13.1.12 PPEDc=EDc*PPEDD

13.1.13 PPPW=WDc/PPEDc

13.1.14 ETPP1K=(PPEDc*PPC1KI)

13.1.15 ETPP3M=(PPEDc*PPC3MI)

13.1.16 PPHR=HRT3Mc*PPCF

14 Defines relevant parameters. WT1Kcx=WDcx*1KSx

14.1.1 ET1Kcx=EDx*1KSx

14.1.2 WT3MScx=WDcx*3MSx

14.1.3 ET3MScx=EDcx*3MSx

14.2 Pwcx=WDcx/EDx

14.3 If mETx>0 then do:PwK=WT1KS/ET1KS END

15 Pw3M=WT3MS/ET3MS

While the present invention has been described with reference to specific embodiments, the description is illustrative of the invention and is not to be construed as limiting the invention. Various modifications may occur to those skilled in the art without departing from the true spirit and scope of the invention as defined by the appended claims.

What is claimed is:

1. A method of providing a personalized profile for an individual, comprising the steps of:
inputting individual information, which includes a series of personal anthropometric measurements, physiological measurements, and measurements of performance; and
processing the individual information to evaluate one or more parameters of the individual and provide, for the individual, a personalized performance-energetic profile of a current and potential level of training, the profile being defined on universal standards, and the values of the parameters being dependent only on the individual information.

2. The method according to claim 1, further comprising the step of transforming the information into a standard form to generate the profile.

3. The method according to claim 1, wherein the processing step includes a series of equations based on laws regarding a performance to provide the personalized profile,
wherein a first law is: at a constant distance, a duration is a linear function of a mean speed of any performance;
a second law is: at a constant mean speed, the duration is a linear function of the distance of any performance;
a third law is: at a constant duration, the distance is an inverse hyperbolic function of the mean speed for any given performance; and
a fourth law is: with maximal effort starting from a stationary position, the maximal mean speed is a function of the distance and duration until maximum maximal speed is achieved, and after reaching the acceleration phase, the distance and duration is an inverse function of the maximal mean speed until exhaustion occurs in the deceleration phase,
the first, second and third laws being independent of an internal state, a class or an external state,
the internal state being defined as a state of the individual's bio-physical characteristics, the class being any physical performance which is measured in distance and duration, and the external state being factors or external conditions which affect the performance.

4. The method according to claim 3, wherein the acceleration phase curve approaches a hyperbola at end points while the deceleration phase approaches a parabola at the end points.

5. The method according to claim 1, wherein the processing step includes a series of equations based on laws regarding a performance-energetics to provide the personalized profile,
wherein a first law is: a rate of energy expended per unit of time is a linear function of a mean speed of a performance which is dependent on an internal state, a class or an external state;
a second law is: at a constant mean speed, the energy time rate is a linear function of an energy distance rate which is dependent on an internal state, a class or an external state;
a third law is: at a constant rate of the energy expenditure, a mean speed is an inverse hyperbolic function of the energy expended per unit distance, which is independent of the class, external state or internal state;
a fourth law is: a work expenditure and an energy requirement in any performance is a linear function of the distance, which is independent of the mean speed, class, external state or internal state;
the internal state being defined as a state of the individual's bio-physical characteristics, class being any physical performance which is measured in distance and duration, and the external state being factors or external conditions which affect the performance.

6. The method according to claim 1, wherein the processing step includes the step of:
estimating a work parameter that the individual requires for a specific type of physical performance.

7. The method according to claim 1, wherein the processing step includes the step of:
estimating a physical fitness assessment on a universal scalar standard.

8. The method according to claim 1, wherein the processing step includes the step of:
estimating energy requirements per unit distance and duration for any class, external state and internal state,
the internal state being defined as a state of the individual's bio-physical characteristics, class being any physical performance which is measured in distance and duration, and the external state being factors or external conditions which affect the performance.

9. A system for providing a personalized profile to an individual, comprising:
an input module for inputting individual information, which includes a series of personal anthropometric measurements, physiological measurements, and measurements of performance; and
a core engine for processing the individual information to evaluate one or more parameters of the individual and provide, for the individual, a personalized performance-energetic profile of a current and potential level of training, the profile being defined on universal standards, and the values of the parameters being dependent only on the individual information.

10. The system according to claim 9, further comprising a module for transforming the information into a standard form to provide the information in the standard form to the core engine.

11. The system according to claim 9, wherein the core engine performs a series of equations based on laws regarding a performance to provide the personalized profile,
wherein a first law is: at a constant distance, a duration is a linear function of a mean speed of any performance;
a second law is: at a constant mean speed, the duration is a linear function of the distance of any performance;
a third law is: at a constant duration, the distance is an inverse hyperbolic function of the mean speed for any given performance; and
a fourth law is: with maximal effort starting from a stationary position, the mean speed is a function of the distance and duration until maximum speed is achieved, and after reaching the acceleration phase, the distance and duration is an inverse function of the mean speed until exhaustion occurs as deceleration phase,
the first, second and third laws being independent of an internal state, a class or an external state,
the internal state being defined as a state of the individual's bio-physical characteristics, the class being any physical performance which is measured in distance and duration, and the external state being factors or external conditions which affect the performance.

12. The system according to claim 11, wherein the acceleration phase curve approaches a hyperbola at end points while the deceleration phase approaches a parabola at the end points.

13. The system according to claim 9, wherein the core engine performs a series of equations based on laws regarding a performance-energetics to provide the personalized profile,
wherein a first law is: a rate of energy expended per unit of time is a linear function of a mean speed of a performance which is dependent on an internal state, a class or an external state;
a second law is: at a constant mean speed, the energy time rate is a linear function of an energy distance rate which is dependent on an internal state, a class or an external state;
a third law is: at a constant rate of the energy expenditure, a mean speed is an inverse hyperbolic function of the energy expended per unit distance, which is independent of the class, external state or internal state;
a fourth law is: a work expenditure and an energy requirement in any performance is a linear function of the distance, which is independent of the mean speed, class, external state or internal state;
the internal state being defined as a state of the individual's bio-physical characteristics, class being any physical performance which is measured in distance and duration, and the external state being factors or external conditions which affect the performance.

14. The system according to claim 9, wherein the input module includes a module for inputting personal information, anthropometric measurements, performance measurements and physiological measurements of the individual, and a module for providing questionnaires to collect personal data related to the performance.

15. The system according to claim 9, wherein the input module includes an interactive module to request a user to input the information in accordance with an instruction.
